(19) United States
(12) Patent Application Publication
(10) Pub. No.: US 2024/0013082 A1
(43) Pub. Date: Jan. 11, 2024

(54) SYSTEMS AND METHODS FOR SIMULATION OF QUANTUM CIRCUITS USING DECOUPLED HAMILTONIANS

(71) Applicant: ALIBABA GROUP HOLDING LIMITED, George Town, Grand Cayman (KY)

(72) Inventors: Dawei DING, San Diego, CA (US); Huihai ZHAO, Beijing (CN); Yaoyun SHI, Bellevue, WA (US)

(21) Appl. No.: 18/252,456

(22) PCT Filed: Nov. 20, 2020
(86) PCT No.: PCT/CN2020/130302

§ 371 Date: May 10, 2023

(51) Int. Cl. G06N 10/20; G06F 17/16

(52) U.S. Cl. CPC G06N 10/20; G06F 17/16

(57) ABSTRACT

Methods and techniques are provided for simulating a quantum circuit. A system can perform operations including generating a transformed Hamiltonian corresponding to a quantum circuit. The transformed Hamiltonian can include transformed local and coupling Hamiltonians. Generation of the transformed Hamiltonian can include obtaining a charge coupling matrix and a flux coupling matrix of an original Hamiltonian corresponding to the quantum circuit and at least partially diagonalizing the charge coupling matrix and the flux coupling matrix. The operations can further include determining a limited eigenbasis including a number of eigenvectors of the transformed local Hamiltonian, projecting the transformed coupling Hamiltonian and the transformed local Hamiltonian onto the limited eigenbasis, and generating an at least partially decoupled Hamiltonian by combining the projection of the transformed coupling and local Hamiltonians. The operations can further include simulating a behavior of the quantum circuit using the at least partially decoupled Hamiltonian.

### TECHNICAL FIELD

The present disclosure generally relates to quantum computing, and more particularly, to simulation of quantum circuits by a classical computer using an at least partially decoupled Hamiltonian.

### BACKGROUND

The design and validation of quantum computers must be performed using classical computers, which poses a problem, as quantum computers are constructed to perform certain tasks impracticable for classical computers. For example, as quantum computer designs become more sophisticated and involve larger quantum circuits, naive simulation techniques become computationally unfeasible. For example, qubit designs such as the 0-π qubit involve three degrees of freedom, or modes, and so simulating multiple such qubits would involve six modes or more. In addition, components of the quantum computer design beyond the qubits may also require simulation. Accordingly, naive methods of simulating such a quantum circuit would result in a high-dimensional Hamiltonian, which would be difficult to diagonalize or exponentiate for simulating the behavior of the quantum computer design.

### SUMMARY

The disclosed systems and methods relate to simulation of a quantum circuit using an at least partially decoupled Hamiltonian. This at least partially decoupled Hamiltonian can be generated using a linear transformation of an original Hamiltonian associated with the quantum circuit.

The disclosed embodiments include a method for simulating a quantum circuit using a computer that processes bits. The method can include obtaining a representation of a quantum circuit. The method can further include generating a transformed Hamiltonian corresponding to the quantum circuit. The transformed Hamiltonian can include a transformed local Hamiltonian and a transformed coupling Hamiltonian. The method can further include determining a limited eigenbasis including a number of eigenvectors of the transformed local Hamiltonian. The method can further include projecting the transformed coupling Hamiltonian, the transformed coupling Hamiltonian expressed in terms of modes of the transformed local Hamiltonian, onto the limited eigenbasis. The method can further include projecting the transformed local Hamiltonian onto the limited eigenbasis. The method can further include generating an at least partially decoupled Hamiltonian by combining the projection of the transformed coupling Hamiltonian and the projection of the transformed local Hamiltonian. The method can further include simulating, by the computer, a behavior of the quantum circuit using the at least partially decoupled Hamiltonian.

The disclosed embodiments include a system for simulating a quantum circuit using a computer that processes bits. The system can include at least one processor and at least one computer readable medium. The computer readable medium can contain instructions that, when executed by the at least one processor, cause the system to perform operations. The operations can include generating a transformed Hamiltonian corresponding to a quantum circuit. The transformed Hamiltonian can include a transformed local Hamiltonian and a transformed coupling Hamiltonian. Generation of the transformed Hamiltonian can include obtaining a charge coupling matrix and a flux coupling matrix of an original Hamiltonian corresponding to the quantum circuit and at least partially diagonalizing the charge coupling matrix and the flux coupling matrix. The operations can further include determining a limited eigenbasis including a number of eigenvectors of the transformed local Hamiltonian. The operations can further include projecting the transformed coupling Hamiltonian, expressed in terms of modes of the transformed local Hamiltonian, onto the limited eigenbasis. The operations can further include projecting the transformed local Hamiltonian onto the limited eigenbasis. The operations can further include generating an at least partially decoupled Hamiltonian by combining the projection of the transformed coupling Hamiltonian and the projection of the transformed local Hamiltonian. The operations can further include simulating a behavior of the quantum circuit using the at least partially decoupled Hamiltonian.

The disclosed embodiments include a non-transitory, computer-readable medium containing instructions that are executable by at least one processor of a system to cause the system to perform operations. The operations can include generating a transformed Hamiltonian corresponding to a quantum circuit. The transformed Hamiltonian can include a transformed local Hamiltonian and a transformed coupling Hamiltonian. Generation of the transformed Hamiltonian can include obtaining a charge coupling matrix and a flux coupling matrix of an original Hamiltonian corresponding to the quantum circuit and at least partially diagonalizing the charge coupling matrix and the flux coupling matrix. The operations can further include determining a limited eigenbasis including a number of eigenvectors of the transformed local Hamiltonian. The operations can further include projecting the transformed coupling Hamiltonian, expressed in terms of modes of the transformed local Hamiltonian, onto the limited eigenbasis. The operations can further include projecting the transformed local Hamiltonian onto the limited eigenbasis. The operations can further include generating an at least partially decoupled Hamiltonian by combining the projection of the transformed coupling Hamiltonian and the projection of the transformed local Hamiltonian. The operations can further include simulating, by a computer that processes bits, a behavior of the quantum circuit using the at least partially decoupled Hamiltonian.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which comprise a part of this specification, illustrate several embodiments and, together with the description, serve to explain the principles and features of the disclosed embodiments. In the drawings:

FIG. 1A depicts an exemplary diagram representing a quantum circuit, in accordance with disclosed embodiments.

FIGS. 1B and 1C depict values for components of the quantum circuit of FIG. 1A, in accordance with disclosed embodiments.

FIGS. 1D and 1E depict an exemplary flux coupling matrix and charge coupling matrix for the quantum circuit of FIG. 1A, in accordance with disclosed embodiments.

FIGS. 2A and 2B depict plots of state and transition energies as a function of energy levels per mode for the quantum circuit of FIG. 1A, in accordance with disclosed embodiments.

FIG. 3A depicts a flowchart of an exemplary process for simulating a quantum circuit using a classical computer, in accordance with disclosed embodiments.

FIGS. 3B to 3J depict exemplary equations involved in construction of an at least partially decoupled Hamiltonian for use in simulating a quantum circuit, in accordance with disclosed embodiments.

FIG. 4 depicts a flowchart of an exemplary process for selecting a transformed Hamiltonian for use in simulating a quantum circuit, in accordance with disclosed embodiments.

FIG. 5A depicts a flowchart of an exemplary simultaneous approximate diagonalization process for generating a transformed Hamiltonian, in accordance with disclosed embodiments.

FIGS. 5B to 5D depict a transformation matrix and transformed charge and flux coupling matrices generated by applying the process of FIG. 5A to the quantum circuit of FIG. 1A, in accordance with disclosed embodiments.

FIGS. 5E and 5F depict plots of state and transition energies as a function of energy levels per mode for an at least partially decoupled Hamiltonian generated using the transformed Hamiltonian of FIGS. 5B to 5D, in accordance with disclosed embodiments.

FIG. 6A depicts a flowchart of an exemplary inductor-only symplectic diagonalization process for generating a transformed Hamiltonian, in accordance with disclosed embodiments.

FIGS. 6B to 6J depict exemplary equations involved in inductor-only symplectic diagonalization, in accordance with disclosed embodiments.

FIGS. 6M to 6O depict a transformation matrix and transformed charge and flux coupling matrices generated by applying the process of FIG. 6A to the quantum circuit of FIG. 1A, in accordance with disclosed embodiments.

FIGS. 6P and 6Q depict plots of state and transition energies as a function of energy levels per mode for an at least partially decoupled Hamiltonian generated using the transformed Hamiltonian of FIGS. 6M to 6O, in accordance with disclosed embodiments.

FIG. 7A depicts a flowchart of an exemplary full symplectic diagonalization process for generating a transformed Hamiltonian, in accordance with disclosed embodiments.

FIGS. 7B to 7H depict exemplary equations involved in inductor-only symplectic diagonalization, in accordance with disclosed embodiments.

FIGS. 7I to 7K depict a transformation matrix and transformed charge and flux coupling matrices generated by applying the process of FIG. 7A to the quantum circuit of FIG. 1A, in accordance with disclosed embodiments.

FIGS. 7L and 7M depict plots of state and transition energies as a function of energy levels per mode for an at least partially decoupled Hamiltonian generated using the transformed Hamiltonian of FIGS. 7I to 7K, in accordance with disclosed embodiments.

FIG. 8 depicts a classical computer suitable for simulating quantum circuits using an at least partially decoupled Hamiltonian, in accordance with disclosed embodiments.

FIG. 9 illustrates an exemplary quantum circuit simulator, consistent with some embodiments of the present disclosure.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

Quantum computers offer the ability to perform certain tasks (equivalently, solve certain problems) thought to be intractable to classical computers, including any possible future classical computers. To understand the advantage of quantum computers, it is useful to understand how they contrast to classical computers. A classical computer operates according to digital logic. Digital logic refers to a type of logic system that operates on units of information called bits. A bit may have one of two values, usually denoted 0 and 1, and is the smallest unit of information in digital logic. Operations are performed on bits using logic gates, which take one or more bits as input and give one or more bits as output. Typically, a logic gate usually only has one bit as output (though this single bit may be sent as input to multiple other logic gates) and the value of this bit usually depends on the value of at least some of the input bits. In modern-day computers, logic gates are usually composed of transistors and bits are usually represented as the voltage level of wires connecting to the transistors. A simple example of a logic gate is the AND gate, which (in its simplest form) takes two bits as input and gives one bit as output. The output of an AND gate is 1 if the value of both inputs is 1 and is zero otherwise. By connecting the inputs and outputs of various logic gates together in specific ways, a classical computer can implement arbitrarily complex algorithms to accomplish a variety of tasks.

On a surface level, quantum computers operate in a similar way to classical computers. A quantum computer operates according to a system of logic that operates on units of information called qubits (a portmanteau of “quantum” and “bit”). A qubit is the smallest unit of information in quantum computers and the qubit may have any linear combination of two values, usually denoted |0> and |1>. In other words, the value of a qubit, denoted |ψ>, could be equal to α|0>+β|1> for any combination of α and β where 60 and β are complex numbers and |α|²+|β|²=1. Operations are performed on qubits using quantum logic gates, which take one or more qubits as input and gives one or more qubits as output. Given the low-level nature of most current quantum systems, quantum algorithms are typically expressed in terms of their underlying quantum circuits. In turn, quantum circuits are composed of quantum gates, the fundamental components that directly manipulate qubits.

Superconducting quantum circuits are one of the leading platforms to realize quantum computing. Although there are many existing designs, designing novel circuits to store and process quantum information is still an active area of research. One important step in the design process can be the ability to simulate the dynamics of a quantum circuit on a classical computer. However, the simulation of large quantum circuits can be quite challenging. Indeed, this is why quantum computers can complete computational tasks that are intractable for classical computers. Despite this hinderance, it remains desirable to simulate small scale quantum circuits in order to understand how qubits behave and interact with each other.

Currently, for many existing designs, the circuits for one or a few qubits are simple enough that they yield to straightforward numerical simulation techniques. In particular, the Hamiltonian of the circuits can be easily diagonalized. However, as qubit designs become more sophisticated and larger circuits are involved, these naive simulation techniques are no longer appropriate. For example, more sophisticated qubit designs such as the 0-π qubit involve three degrees of freedom, or modes, and so simulating multiple such qubits would involve six modes or more. In addition, resonator cavities often need to be included in the simulation as well. Naive methods to discretize the Hilbert space for this circuit would lead to a very high dimensional Hamiltonian that can be difficult to diagonalize or exponentiate for time evolution. The problem becomes how to analyze quantum circuits in a computationally efficient manner.

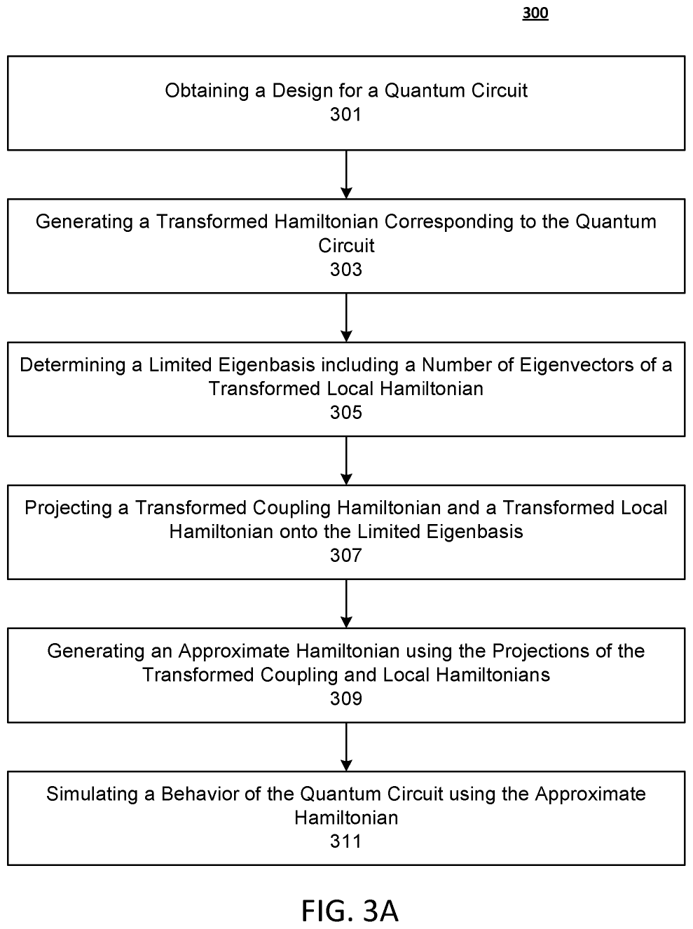

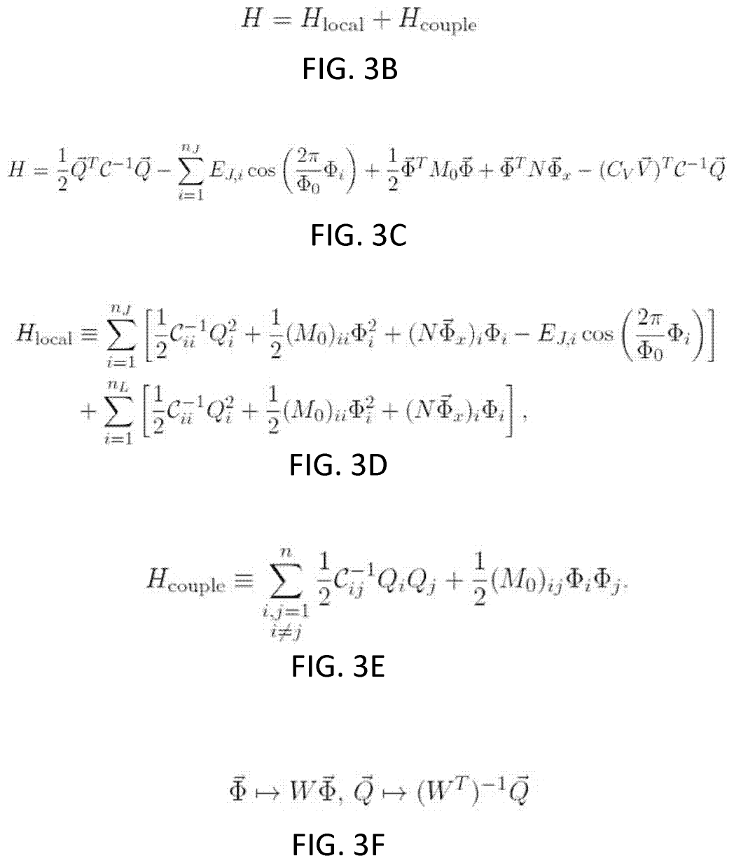

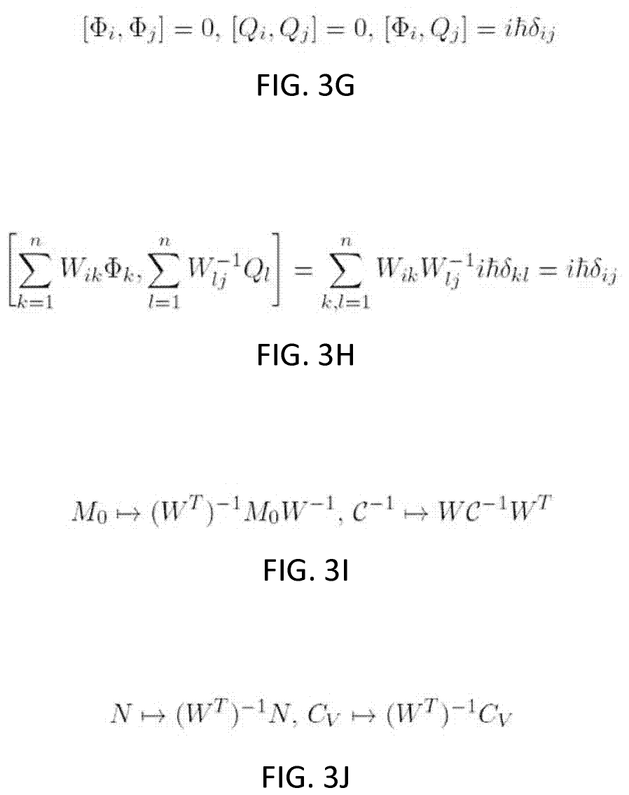

Perturbation theory offers an approach to computationally efficient analysis of weakly coupled quantum circuits. In general, a Hamiltonian H can be expressed, as depicted in FIG. 3B, as a sum of H_{local} (consisting of all local terms) and H_{couple} (consisting of all coupling terms). When a magnitude of the coupling terms is small compared to the local terms (e.g., a norm of H_{local} is much greater than a norm of H_{couple}) then H_{couple} can be treated as a perturbation.

According to this approach, H_{local} can be diagonalized. In some instances, each local Hamiltonian can be diagonalized using standard numerical techniques for quantum systems with one degree of freedom. The low energy eigenstates of H then approximately involve only low-energy eigenstates of H_{local}, a projection of H into the low-energy eigenspace of H_{local} approximately preserves the low-energy spectrum and eigenstates of H. H_{couple} can be expressed as a sum of tensor products of local operators, which in turn can be expressed in the eigenbasis of the corresponding local Hamiltonian. Components of H_{couple} involving high-energy eigenstates can be discarded. Finally, the projection onto the first few eigenstates of H_{local} can be added to the truncated H_{couple}. The resulting Hamiltonian can approximate H in the low energy eigenspace.

How well the Hamiltonian approximates H can depend on the coupling between modes of the Hamiltonian and the number of eigenstates included in the eigenbasis. In general, a greater degree of coupling requires inclusion of more eigenstates to achieve a desired degree of accuracy. However, the more eigenstates included in the approximate Hamiltonian, the more computational resources required to simulate the quantum circuit.

The disclosed embodiments concern methods of linearly transforming circuit modes to reduce inter-mode couplings. Applying perturbation theory to the Hamiltonian of the transformed modes, this transformed Hamiltonian can be expressed as a transformed local Hamiltonian and a transformed coupling Hamiltonian. As described above, the transformed coupling Hamiltonian can be projected onto an eigenbasis of the transformed local Hamiltonian. Numerical methods (e.g., the Lanczos algorithm, or another suitable method) can then be used to find or compute low energy states, permitting the low energy properties of the quantum circuit can be obtained to a good approximation.

The disclosed linear transformations of quantum circuit modes can be computed from the Hamiltonian of the quantum circuit (which can be obtained through standard circuit quantization techniques). The Hamiltonian can include contributions from capacitive terms, inductive terms, and (Josephson) junction terms. The inter-mode coupling terms are all in the capacitive and inductive terms which can be summarized by coupling matrices that describe the charge and flux coupling between modes, including self-couplings (e.g., local terms). The algorithm computes different linear transformations on the circuit modes which effectively transforms the coupling matrices to reduce their off-diagonal terms which are the coefficients of coupling terms.

The disclosed linear transformations affect modes' flux and charge operators. The transformed operators still obey the canonical commutation relations. One disclosed transformation performs the same orthogonal transformation to both the flux and charge operators for the inductor modes with an optimization loop to reduce couplings. Another disclosed transformation diagonalizes the submatrices of the coupling matrices that correspond to inductor modes. This is possible by Williamson's theorem. A third disclosed transformation fully diagonalizes both coupling matrices, at the cost of introducing flux couplings between the transformed modes via the junction terms.

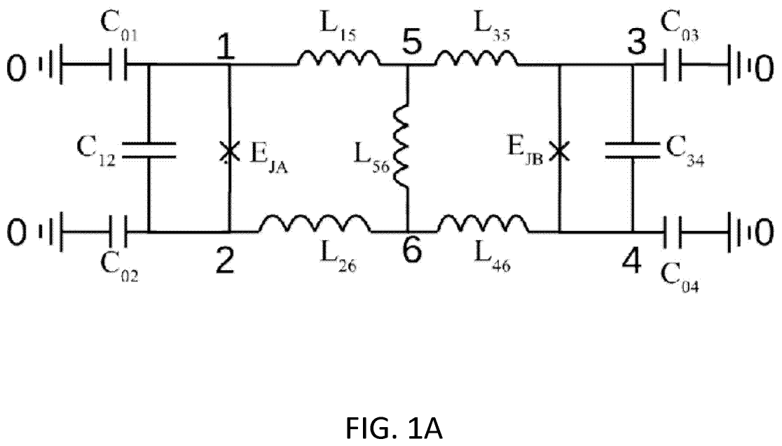

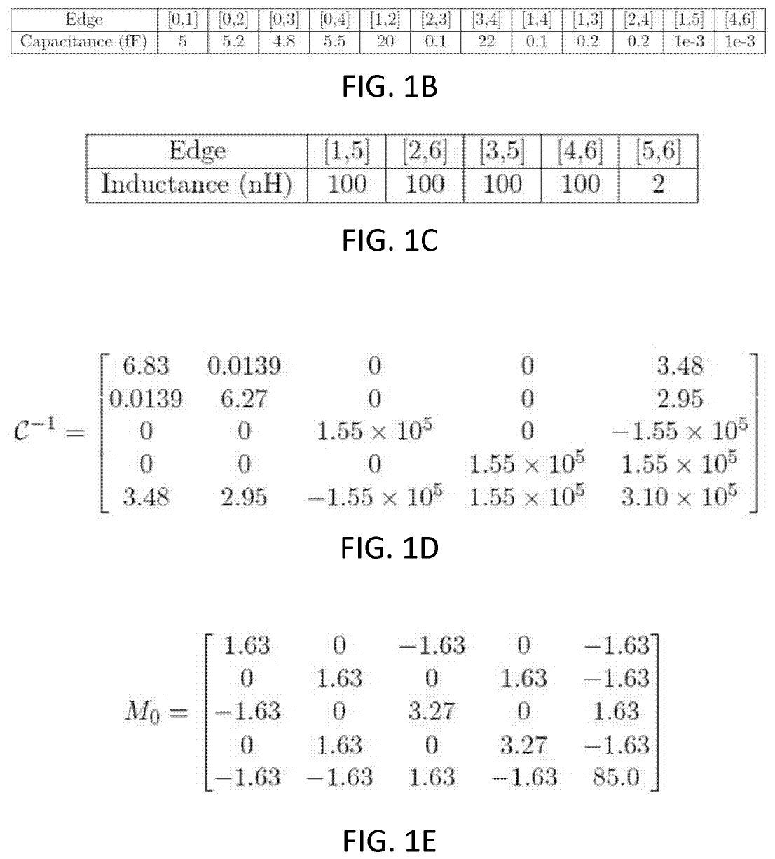

FIG. 1A depicts an exemplary diagram representing a quantum circuit suitable for simulation, in accordance with disclosed embodiments. This quantum circuit includes two strongly inductively coupled qubits. For clarity capacitors on edges [1,3], [1,4], [2,3], [2,4], [1,5], [4,6] are not included. The values for the capacitances and inductances of the components of this quantum circuit are given in FIG. 1B and FIG. 1C, respectively. With these parameters, and

after removing the free modes as disclosed in the following paragraph [41]-[71], the Hamiltonian given in FIG. 3C can be obtained.

As would be appreciated by those of skilled in the art, the original Hamiltonian for a quantum circuit can be derived in a variety of ways. As a non-limiting example, a Hamiltonian for a general superconducting quantum circuit can be derived using the method disclosed in “Circuit theory for decoherence in superconducting charge qubits,” G. Burkard, Physical Review B, April 2005, which is hereby incorporated by reference herein in its entirety and will be referred as Burkard in the present disclosure. In Burkard, the derived dissipation-less Hamiltonian of a general superconducting quantum circuit (e.g., quantum circuit 201) takes the form below:

$$H = \frac{1}{2} {( \vec{Q} - {C}_{V} \vec{V} )}^{T} {C}^{- 1} ( \vec{Q} - {C}_{V} \vec{V} ) - {\sum }_{i = 1}^{{n}_{J}} {E}_{J , i} cos ( \frac{2 π}{{Φ}_{0}} {Φ}_{i} ) + \frac{1}{2} {\vec{Φ}}^{T} {M}_{0} \vec{Φ} + {\vec{Φ}}^{T} N \vec{{Φ}_{x}} \qquad ( Equation 1 )$$

Here, \vec{Φ} and \vec{Q} are vectors of a flux operator and a charge operator for circuit modes of quantum circuit 201. \vec{Φₓ} denotes externally applied magnetic fluxes, Φ₀ is the flux quantum, and Φᵢ is a flux variable. \vec{V} is a vector of voltage biases in quantum circuit 201 and C⁻¹, M₀, N, and Cᵥ are the charge coupling matrix, flux coupling matrix, external flux coupling matrix, and voltage coupling matrix, respectively. n_{J} is the number of Josephson junctions and E_{J,i} is the characteristic energy scale of each Josephson junction.

In some embodiments, a number F of free modes of quantum circuit 201 can be given as:

F≡dim(ker(M₀)∩ker(N^{T})∩V_{L}) (Equation 2).

Here, V_{L} is the subspace spanned by inductor fluxes. As denoted in Equation 2, the number F of free modes can be defined as a dimension of subspace(s), which are common in the kernel of flux coupling matrix M₀, the kernel of transposed external flux coupling matrix N^{T}, and the subspace V_{L} spanned by inductor fluxes of quantum circuit 201. In some embodiments, modes in quantum circuit 201 may have a vanishingly small potential term. While in such cases, no modes may be free, modes satisfying a thresholding criterion can be deemed to be free modes. For example, a mode in the Hamiltonian having a potential value smaller than the threshold can be treated as a free mode although the potential value of the mode may not be zero.

According to some embodiments of the present disclosure, flux operators \vec{Φ} and charge operators \vec{Q} can take forms such that free modes can be explicit in the derived Hamiltonian (e.g., represented as Equation 1). In some embodiments (e.g., via an appropriate transformation that diagonalizes the intersection of subspaces in Equation 2), flux operators \vec{Φ} can be represented as \vec{Φ}=[Φ₁, . . . , Φ_{F}, . . . , Φₙ], where Φ₁, . . . , Φ_{F} are flux operators for free modes, Φ_{F+1}, . . . , Φₙ are flux operators for non-free modes, and n is the total number of modes in the Hamiltonian. Similarly, charge operators \vec{Q} can be represented as \vec{Q}=[Q₁, . . . , Q_{F}, . . . Qₙ], where Q₁, . . . , Q_{F} are charge operators for free modes and Q_{F+1}, . . . Qₙ are charge operators for non-free modes. Consistent with this representation of flux operators \vec{Φ} and charge operators \vec{Q}, the elements of first F rows of external flux coupling matrix N and first F rows and first F columns of flux coupling matrix M₀ may all be zero.

In some embodiments, a transformed Hamiltonian that decouples free modes from non-free modes can be obtained, e.g., by linearly transforming circuit modes of quantum circuit 201 to effectively perform Gaussian elimination on the inverse of charge coupling matrix C⁻¹ (e.g., C). The same Gaussian elimination can then be performed on flux coupling matrix M₀, in accordance with the canonical transformation requirement. Accordingly, the transformed Hamiltonian will possess the same number of free modes as the original Hamiltonian. The extracted Hamiltonian can then be obtained by removing the free modes from the transformed Hamiltonian.

Consistent with disclosed embodiments, a transform matrix W can be defined such that free modes components can be decoupled from non-free modes components in charge coupling matrix C⁻¹. Charge coupling matrix C⁻¹ can be an inverse of effective capacitance matrix C of quantum circuit 201, which can be positive definite. For f∈{1, 2, . . . , F}, matrices W_{f} and C_{f} can be iteratively defined. Matrix W_{f} can be defined as an n×n identity matrix, except for column f, which has entries:

$${( {W}_{f} )}_{if} ≡ - \frac{{( {C}_{f - 1} )}_{if}}{{( {C}_{f - 1} )}_{ff}}$$

where matrix C_{f} is defined as C_{f}≡W_{f}C_{f-1}W_{f}^{T}. Matrix C₀ can be defined as the effective capacitance matrix C of quantum circuit 201. Because matrix C_{f-1} is positive definite, matrix W_{f} can be proven by induction to be well-defined (and therefore element (C_{f-1})_{ff} is not zero). First, matrix C₀≡C can be positive definite as required by Burkard. Second, assuming that matrix C_{f-1} is positive definite, matrix W_{f} is well-defined because element (W_{f})_{ff}=−1. Therefore, the f-th column of matrix W_{f} is linearly independent of other columns of matrix W_{f} (as the other columns of W_{f} constitute an identity matrix by definition). Thus, W_{f} has full rank, which implies matrix C_{f}≡W_{f}C_{f-1}W_{f}^{T} is also positive definite.

The final matrix:

C′≡WCW^{T} (Equation 3).

where W≡Π_{f=1}^{F}W_{f}, has vanishing off-diagonal elements for its first F rows and columns, which can be verified as follows. The off-diagonal entries of f-th column of matrix C_{f} can be calculated as:

$${( {C}_{f} )}_{if} = {\sum }_{j , k = 1}^{n} {( {W}_{f} )}_{ij} {( {C}_{f - 1} )}_{jk} {( {W}_{f} )}_{fk} = - {\sum }_{j = 1}^{n} {( {W}_{f} )}_{ij} {( {C}_{f - 1} )}_{jf} = - [ - \frac{{( {C}_{f - 1} )}_{if}}{{( {C}_{f - 1} )}_{ff}} {( {C}_{f - 1} )}_{ff} + 1 \times {( {C}_{f - 1} )}_{if} ] = 0.$$

Due to symmetry of matrix C_{f}, off-diagonal entries in the f-th row matrix C_{f} are also vanishing, i.e., zeros. It can also be shown that off-diagonal terms of matrix C_{f} for 1 to f−1 -th rows and 1 to f−1-th columns are also vanishing, which can be established by induction. First, this is true for matrix C₁. Second, it is assumed that the same is true for matrix C_{f}, which implies element (C_{f})_{if+1}=0 (for i<f+1), which implies that the same is true for matrix W_{f+1}, i.e., (W_{f+1})_{if+1}=0 (for i<f+1). By symmetry, the same holds for the f+1-th row of matrix C_{f} and the same holds true for matrix W_{f+1}. Hence, both matrices C_{f}and W_{f+1}, and therefore matrix W_{f+1}^{T} are block diagonal matrices with block dimensions 1, . . . , 1, n−f, which implies the same is true for matrix C_{f+1}.

As established above, every matrix W_{f} is full rank and therefore invertible, which implies that transform matrix W is invertible. Hence, transformed charge coupling matrix

C′⁻=(W^{T})⁻¹C⁻¹W⁻¹ (Equation 4).

is well defined. Since transformed charge matrix C′ is block diagonal with block dimensions 1, . . . , 1, n−F, transformed charge coupling matrix C′⁻¹ is also block diagonal with block dimensions 1, . . . , 1, n−F.

Furthermore, the submatrices of charge coupling matrix C⁻¹ and transformed charge coupling matrix C′⁻¹ that correspond to indices greater than F (the number of free modes) are the same. This can be proved as follows. W_{f}⁻¹=W_{f} is established because when i=j:

(W_{f}W_{f})ᵢᵢ=Σₖ₌₁ⁿ(W_{f})ᵢₖ(W_{f})ₖᵢ=(W_{f})ᵢᵢ²=1;

and when i≠j:

$${( {W}_{f} {W}_{f} )}_{i j} = {\sum }_{k = 1}^{n} {( {W}_{f} )}_{i k} {( {W}_{f} )}_{k j} = {( {W}_{f} )}_{i i} {( {W}_{f} )}_{i j} + {( {W}_{f} )}_{i f} {( {W}_{f} )}_{i j}$$

$$= {δ}_{j f} ( {( {W}_{f} )}_{i i} {( {W}_{f} )}_{i f} + {( {W}_{f} )}_{i f} {( {W}_{f} )}_{f f} ) = {δ}_{j f} ( {( {W}_{f} )}_{i f} - {( {W}_{f} )}_{i f} ) = 0$$

where δ_{if}((W_{f})_{if}−(W_{f})_{if}) follows because i≠j and i≠f. Here, δ_{if}=1 when j=f and δ_{if}=0 when j≠f.

For i, j>F, the following relationship is established:

$${( {C}_{f}^{- 1} )}_{i j} = {( {W}_{f}^{T} {C}_{f - 1}^{- 1} {W}_{f} )}_{i j} = {\sum }_{k , l = 1}^{n} {( {W}_{f} )}_{k i} {( {C}_{f - 1}^{- 1} )}_{k l} {( {W}_{f} )}_{l j} = {( {W}_{f} )}_{i i} {( {C}_{f - 1}^{- 1} )}_{i j} {( {W}_{f} )}_{j j}$$

$$= {( {C}_{f - 1}^{- 1} )}_{i j}$$

Therefore, the submatrices of charge coupling matrix C⁻¹ and transformed charge coupling matrix C′⁻¹ that correspond to indices greater than F are the same. Thus, the linear transformation does not affect the charge couplings of the non-free modes of the original Hamiltonian.

The linear transformation of the charge operators \vec{Q}′ can be defined as:

\vec{Q}′→W\vec{Q} (Equation 5).

In order to preserve the following canonical commutation relations between canonical conjugate quantities in the Hamiltonian,

[Φᵢ, Φᵢ]=0

[Qᵢ, Qᵢ]=0

[Φᵢ, Qᵢ]=iℏδᵢⱼ

the flux operator \vec{Φ} can also be transformed as:

\vec{Φ}→(W^{T})⁻¹\vec{Φ} (Equation 6).

This preserves the canonical commutation relations. For i>F, Φᵢ=ΣⱼWⱼᵢΦⱼ′=Φᵢ′, where \vec{ψ′} ≡(W^{T})⁻¹\vec{Φ} are the transformed flux operators. Accordingly, consistent with disclosed embodiments, the transformed fluxes include the original non-free mode's fluxes. Thus, by removing the free modes in the Hamiltonian in terms of the transformed modes, the Hamiltonian on the original non-free modes can be explicitly obtained. Furthermore, any junction terms in the Hamiltonian are preserved and remain local terms (e.g., terms that involve a single mode, as contrasted with general terms that involve multiple modes, which can be expressed as sums of tensor products of local operators).

Consistent with disclosed embodiments, the linear transformation of the flux modes implies a corresponding transformation of the flux coupling matrix:

M₀→WM₀W^{T} (Equation 7).

This transformation, however, does not affect the element values of the flux coupling matrix, as shown below:

$${( {W}_{f} {M}_{0} {W}_{f}^{T} )}_{i j} = {\sum }_{k , l = 1}^{n} {( {W}_{f} )}_{i k} {( {M}_{0} )}_{k l} {( {W}_{f} )}_{j l} = {\sum }_{k = i , f , l = i , f} {( {W}_{f} )}_{i k} {( {M}_{0} )}_{k l} {( {W}_{f} )}_{j l}$$

$$= {( {W}_{f} )}_{i i} {( {M}_{0} )}_{i j} {( {W}_{f} )}_{j j} = {( {M}_{0} )}_{i j}$$

since the f-th row and f-th column of M₀ are both zero. Accordingly:

M₀=WM₀W^{T}

Therefore, the transformed flux coupling matrix is the same as the original flux coupling matrix.

A similar result holds for the external flux coupling matrix N. The linear transformation of the flux modes implies a corresponding linear transformation of the external flux coupling matrix:

N→WN (Equation 8).

However

$${( {W}_{f} N )}_{ij} = {\sum }_{k = 1}^{n} {( {W}_{f} )}_{i k} {N}_{k j} = {( {W}_{f} )}_{i i} {N}_{i j} = {N}_{ij}$$

Therefore N=WN and the external flux coupling matrix is not affected by the linear transformation of the flux modes. The first F modes in the transformed external flux coupling matrix N are free modes and the flux and external flux couplings of the remaining modes (i.e., non-free modes) of modes remain the same.

The linear transformation implies a corresponding linear transformation of voltage coupling matrix C_{V}:

C_{V}→WC_{V} (Equation 9).

According to some embodiments of the present disclosure, based on Equations 3 to 9, the Hamiltonian of Equation 1 can be represented in terms of the transformed modes as follows:

$$H = \frac{1}{2} {( \vec{{Q}^{′}} - {C}_{V}^{′} \vec{V} )}^{T} {C}^{′ - 1} ( \vec{{Q}^{′}} - {C}_{V}^{′} \vec{V} ) - {\sum }_{i = 1}^{{n}_{J}} {E}_{J , i} cos ( \frac{2 π}{{Φ}_{0}} {Φ}_{i}^{′} ) + \frac{1}{2} {\vec{Φ}}^{′ T} {M}_{0} {\vec{Φ}}^{′} + {\vec{Φ}}^{′ T} N \vec{{Φ}_{x}} . \qquad ( Equation 10 )$$

Here, the transformed Hamiltonian expressed as Equation 10 describes a system of n modes with F free modes that are independent from all other modes. Therefore, according to some embodiments of the present disclosure, the Hamiltonian of the original non-free modes can be extracted by eliminating terms corresponding to free modes' charges from the Hamiltonian of Equation 10.

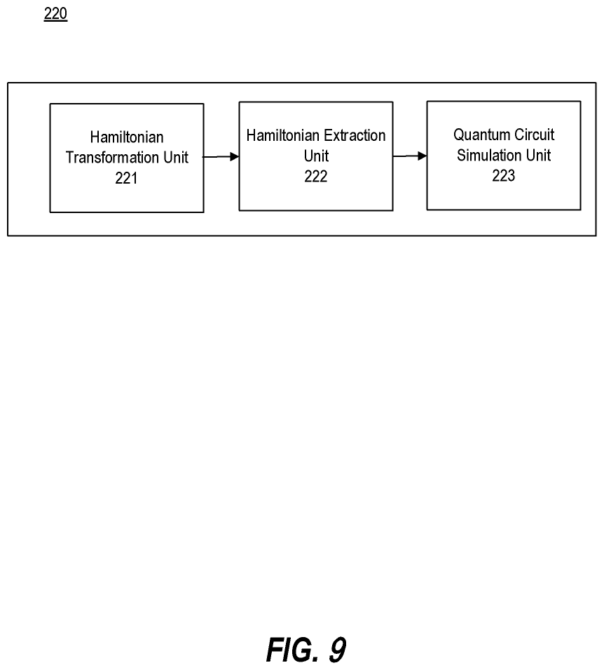

Referring to FIG. 9, Hamiltonian extraction unit 222 can be configured to generate an extracted Hamiltonian of quantum circuit 201, e.g., by removing components of the transformed Hamiltonian corresponding to free modes. The extracted Hamiltonian can be represented as follows:

$${H}_{∖ F} = \frac{1}{2} {\vec{Q}}_{∖ F}^{′ T} {C}_{∖ F}^{- 1} {\vec{Q}}_{∖ F}^{′} - {\sum }_{i = 1}^{{n}_{J}} {E}_{J , i} cos ( \frac{2 π}{{Φ}_{0}} {Φ}_{i} ) + \frac{1}{2} {{\vec{Φ}}_{∖ F}^{T} ( {M}_{0} )}_{∖ F} {\vec{Φ}}_{∖ F} + {\vec{Φ}}_{∖ F}^{T} {N}_{\backslash F} \vec{{Φ}_{x}} - {[ {( {C}_{V}^{′} )}_{∖ F} \vec{V} ]}^{T} {C}_{∖ F}^{- 1} {\vec{Q}}_{∖ F}^{′} . \qquad ( Equation 11 )$$

In Equation 11, the subscript \F means that components corresponding to free modes have been removed from the corresponding operators or matrices. According to some embodiments of the present disclosure, for external flux coupling matrix N and transformed voltage coupling matrix C_{V}′, symbol \F can mean removing rows corresponding to free modes of the transformed Hamiltonian.

Consistent with disclosed embodiments, the extracted Hamiltonian H_{\F} of Equation 11 may not include the identity term proportional to V² (where V is the vector of voltage biases in the circuit). In some embodiments, this term may contribute only a shift to the Hamiltonian and can be disregarded.

Consistent with disclosed embodiments, the drive term proportional to V in the extracted Hamiltonian H_{\F} can equal [(Cᵥ′)_{\F}\vec{V}]^{T}C_{\F}⁻¹\vec{Q}_{†F}′. As shown below, this relationship can follow from the block-diagonal nature of the transformed charge coupling matrix C′⁻¹ and the equivalence between the submatrices of the charge coupling matrix C⁻¹ and the extracted portion of the transformed charge coupling matrix C′⁻¹ corresponding to the non-free modes of the original Hamiltonian. As support for this relationship, consider the following drive term, which includes the free mode:

−(C_{V}′\vec{V})^{T}C′⁻¹\vec{Q}′

Removing free modes from this drive term is equivalent to removing the first F columns of transformed charge coupling matrix C′⁻¹ and the first F entries of transformed charge operator \vec{Q}′. Because transformed charge coupling matrix C′⁻¹ is a block diagonal matrix, the first F rows, once the first F columns of transformed charge coupling matrix C′⁻¹ are removed, are all zeros. Therefore, the first F rows of transformed charge coupling matrix C′⁻¹ and the first F rows of transformed voltage coupling matrix C_{V}′ can also be removed. As explained above, the remaining submatrix of transformed charge coupling matrix C′⁻¹ after removing free modes is the same as that of charge coupling matrix C⁻¹ and thus the drive term of the extracted Hamiltonian H_{\F} can be represented as in Equation 11.

Consistent with disclosed embodiments and in accordance with the derivation of the extracted Hamiltonian provided herein, the extracted Hamiltonian can be obtained by removing the free mode terms in the original Hamiltonian and transforming the voltage coupling matrix C_{V} as depicted in Equation 9. The transformation of the voltage coupling matrix may ensure, in some embodiments, that an analysis using the extracted Hamiltonian in place of the original Hamiltonian will provide the correct results when using voltage sources.

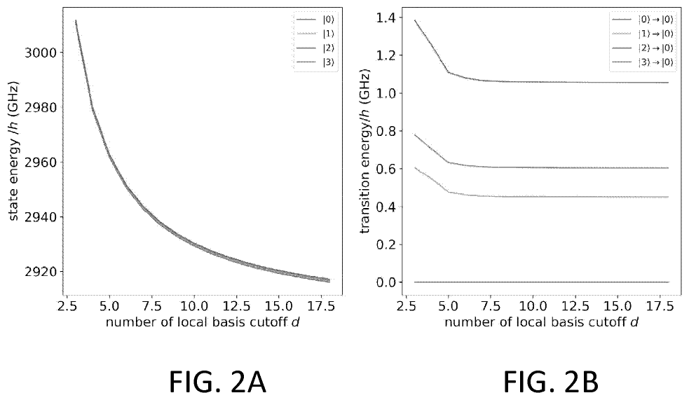

The coupling matrices [symbol] ⁻¹ and M₀ are given in FIG. 1D and FIG. 1E. The coupling terms in the Hamiltonian correspond to the off-diagonal terms in these matrices. The sum of the squares of the off-diagonal terms is 9.61e10. In this non-limiting example, the constants E_{JA} and E_{JB} are defined as follows: E_{JA}=3.0 GHZ·h and E_{JB6b =3.2} GHZ·h. The Hamiltonian can be directly diagonalized and the energies of the low energy states (in FIG. 2A) and the differences between low energy states (in FIG. 2B) plotted as a function of the local Hamiltonian low energy eigenspace onto which the overall Hamiltonian has been projected. The dimension is of each individual mode, so the overall dimension is d⁵ (as there are 5 modes in this system).

If the coupling is small, the energies should converge quickly with increasing local dimension. In this non-limiting example, no decoupling technique has been applied and the state energies do not converge quickly (e.g. they continue to decrease as the number of eigenvectors in the eigenbasis increases beyond seventeen). As the state energies have not converged, the differences between low energy states are not reliable. The systems and methods disclosed herein provide ways to improve upon this base result, allowing for an at least partially decoupled Hamiltonians having state energies and energy transitions that converge more quickly with an increasing number of number of eigenvectors in the eigenbasis.

FIG. 3A depicts a process 300 for simulating the behavior of a quantum circuit using an at least partially decoupled Hamiltonian, in accordance with disclosed embodiments. Process 300 can enable a classical computer to simulate the behavior of the quantum circuit, even when the quantum circuit is configured to perform computations that cannot practicably be performed by a classical computer. Thus process 300 provides a technical improvement in the design or verification of quantum circuits. In some embodiments, a computer can be configured to perform at least some of the steps of process 300, in addition to simulating the behavior of the quantum circuit. The computer can be configured to perform these steps automatically, or at least partially through interactions with a user.

In step 301 of process 300, a representation of a quantum circuit can be obtained. In some embodiments, the representation can be a design of the quantum circuit (e.g., a circuit diagram, or the like). The representation can include data or instructions specifying the components of the quantum circuit and how such components are interconnected. In some embodiments, the representation can be obtained by a computer configured to perform at least some of the steps of process 300. The representation can be obtained as input to a program for performing process 300. This input could come in a variety of forms, both in how the input is represented (e.g., the data structure involved) and what the input represents (e.g., what quantum circuit representation the input is using). In other embodiments, the quantum circuit could be directly created within a program for performing process 300. In some embodiments, the quantum circuit can be received from another system or retrieved from a memory accessible to the computer. The circuit can include one or more qubits.

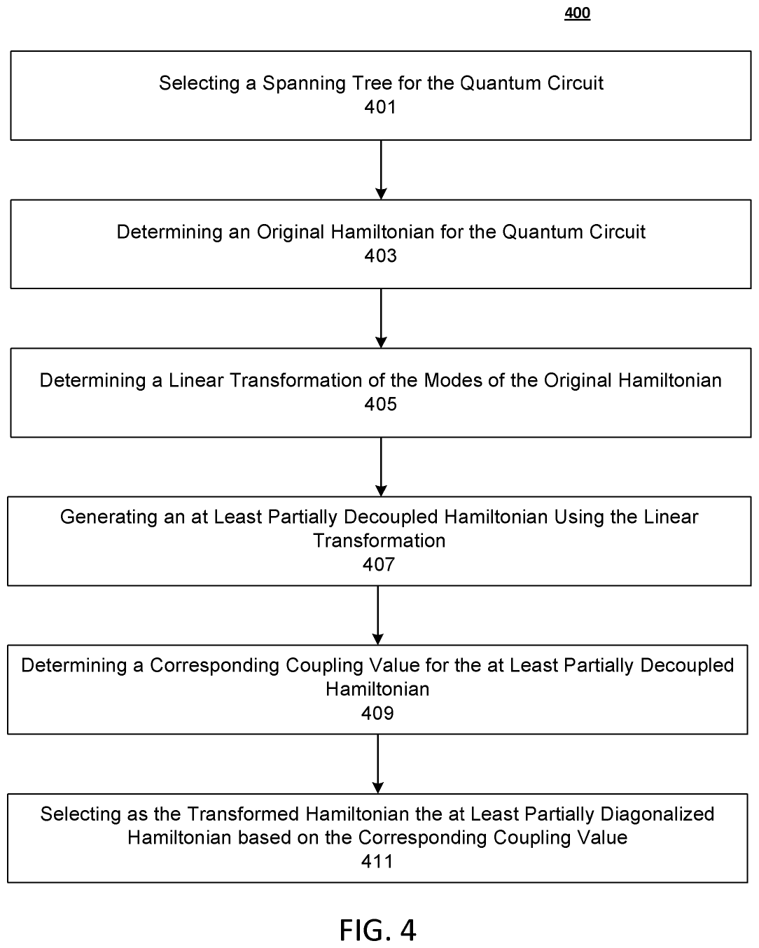

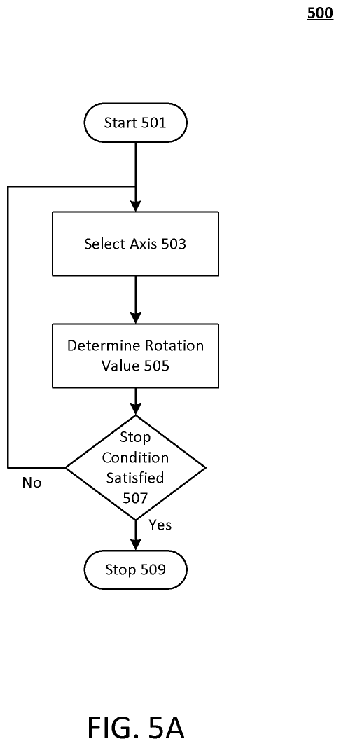

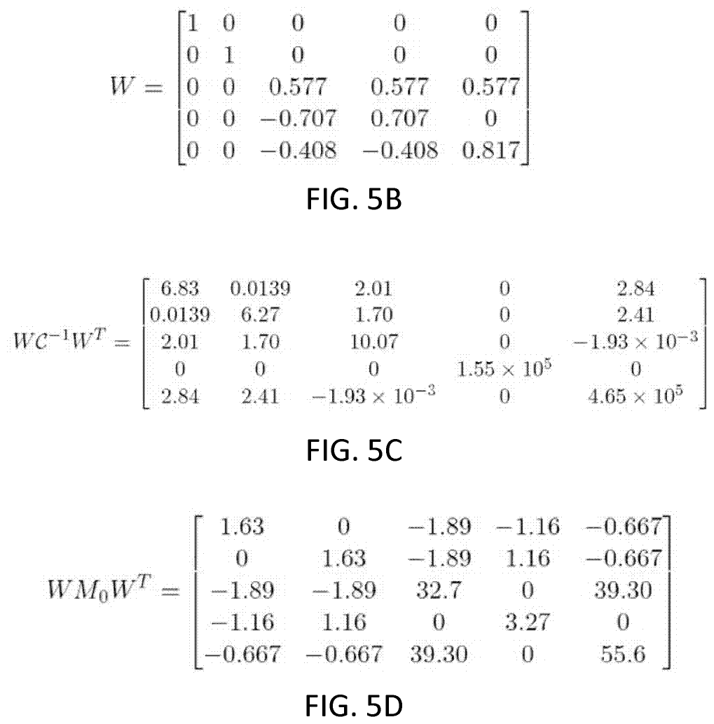

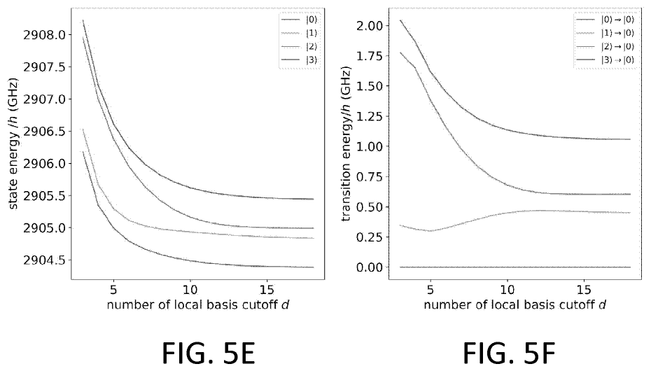

In step 303 of process 300, a transformed Hamiltonian can be generated corresponding to the quantum circuit. The transformed Hamiltonian can be generated from an original Hamiltonian. In some embodiments, the modes of the transformed Hamiltonian can be linear combinations of the modes of the original Hamiltonian. The transformed Hamiltonian can include charge and flux coupling matrices that are at least partially diagonal, as described herein. The transformed Hamiltonian can include a transformed local Hamiltonian and a transformed coupling Hamiltonian. In some embodiments, a single transformed Hamiltonian can be generated. In various embodiments, multiple transformed Hamiltonians can be generated and one of the transformed Hamiltonians can be selected (e.g., as described with regards to FIG. 4). The transformed Hamiltonians can be generated using at least one of the methods described with regards to FIGS. 5A, 6A, and 7A.

It is appreciated that the original Hamiltonian for the quantum circuit can be derived in a variety of ways. As a non-limiting example, a Hamiltonian for a general superconducting quantum circuit can be derived using the method disclosed in “Circuit theory for decoherence in superconducting charge qubits,” G. Burkard, Physical Review B, April 2005, which is hereby incorporated by reference herein in its entirety. In this paper, the derived dissipation-less Hamiltonian takes the form depicted in FIG. 3C, where \vec{Φ}, \vec{Q} are vectors of flux and charge operators for the different modes of the circuit, \vec{V} is the vector of voltage biases in the circuit, [symbol] ⁻¹, M₀, N, C_{V} are the matrices of charge, flux, external flux, and voltage couplings, respectively, n_{J} is the number of Josephson junctions with E_{J,i} being the characteristic energy scale of each junction, Φₓ is the external magnetic flux, and Φ₀ is the flux quantum. In general, the quantum information is encoded in the undriven circuit, so the Hamiltonian of interest is when \vec{V} is set to zero. For convenience of explanation, the disclosed embodiments will be described using this notation. However, they are not limited to a particular representation of the Hamiltonian of a quantum circuit.

The original Hamiltonian for a quantum circuit can be split into local and coupling terms, as depicted in FIG. 3B. Here, H_{local} can be given as depicted in FIG. 3D, where n_{L} can be the number of tree inductors. H_{coupling} can be given as depicted in FIG. 3E, where n≡n_{J}+n_{L} is the total number of modes. H describes a weakly coupled quantum many-body system when the coupling terms [symbol] ᵢⱼ⁻¹, (M₀)ᵢⱼ are small, compared to the local terms.

Given that H_{couple} is purely quadratic, a linear transformation on the modes can be used to reduce off-diagonal entries in [symbol] ⁻¹ and M₀. More specifically, the transformation shown in FIG. 3F can be implemented, where W∈ [symbol] ^{n×n}. This linear transformation can preserve the canonical commutation relations depicted in FIG. 3G. That the first two types are preserved can be easily checked. For the third, the equivalence can be demonstrated as shown in FIG. 3H.

Such a transformation can transform the quadratic coupling matrices using the mappings depicted in FIG. 31. The other coupling matrices of the original Hamiltonian can transform according to the mappings depicted in FIG. 3J. Note that even though the undriven Hamiltonian is considered, the transformation for C_{V} may still be required to obtain the driven Hamiltonian in terms of the transformed modes. The junction term will be transformed as well and may affect determination of an at least partially decoupled Hamiltonian in some embodiments, as discussed herein.

In step 305, a limited eigenbasis can be determined for the transformed local Hamiltonian. A number of the low-energy or otherwise significant eigenvectors of the transformed local Hamiltonian can be selected as the limited eigenbasis. For example, the number can be between 2 and 20, or higher. As a non-limiting example, the 5, 10, or 20 lowest energy eigenvectors of the transformed local Hamiltonian can be selected as the limited eigenbasis. In some embodiments, the number can be predetermined. In other embodiments, the number can depend on a convergence criterion (e.g., a rate of convergence in the energy level of the local transformed Hamiltonian, or the like).

In step 307, the transformed coupling Hamiltonian can be projected onto the limited eigenbasis. The transformed coupling Hamiltonian can be expressed as a sum of tensor products of local operators. The local operators can then be expressed in the limited eigenbasis (e.g., terms of the expression involving eigenstates not including in the limited eigenbasis can truncated).

In step 309, an at least partially decoupled Hamiltonian can be generated. An at least partially decoupled Hamiltonian can combine the projection of the transformed coupling Hamiltonian and the projection of the transformed local Hamiltonian. In some instances, an at least partially decoupled Hamiltonian can be the sum of these projections.

In step 311, a classical computer can simulate the behavior of the quantum circuit using an at least partially decoupled Hamiltonian. In some instances, the classical computer can simulate the time evolution of the state of the quantum circuit (e.g., the time evolution of the states of the modes for the quantum circuit). In various instances, the classical computer can simulate a response of the quantum circuit to an input or other perturbation. The disclosed embodiments are not limited to any particular simulation accomplished using an at least partially decoupled Hamiltonian.

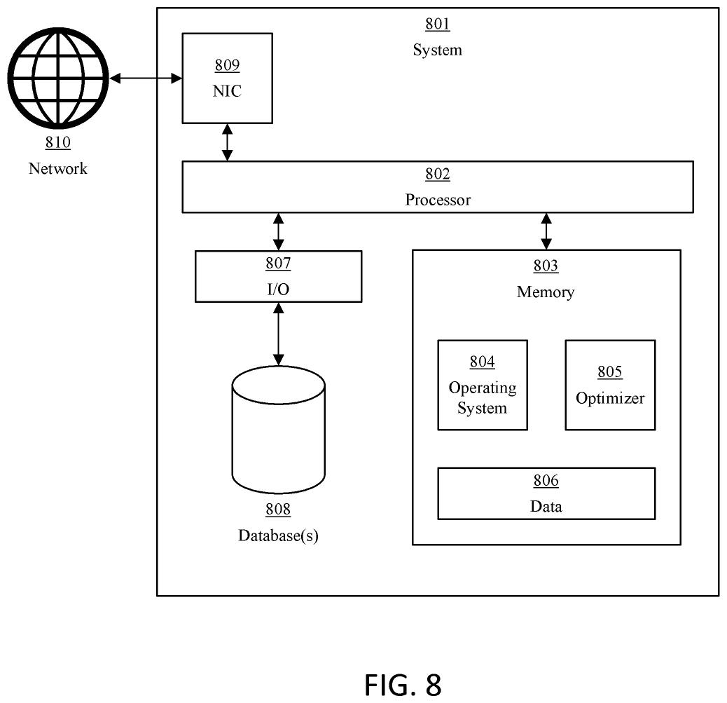

FIG. 4 depicts a flowchart of an exemplary process 400 for selecting a transformed Hamiltonian for use in simulating a quantum circuit, in accordance with disclosed embodiments. In some embodiments, process 400 can be performed as part of step 303 of process 300, described above with regards to FIG. 3A. Process 400 can generate multiple transformed Hamiltonians. One of these transformed Hamiltonians can be selected according to a selection criterion. The selection criteria can concern a degree of coupling between the modes of the transformed Hamiltonian. The selected Hamiltonian can be used to generate an at least partially decoupled Hamiltonian for simulating the quantum circuit. As described above, Hamiltonians with reduced coupling between modes are better suited to approximation using perturbation theory. Accordingly, process 400 can support generation of improved an at least partially decoupled Hamiltonians that support more-accurate simulation of quantum circuits. In some embodiments, a computing device (e.g., as depicted in FIG. 8) can be configured to perform at least some of the steps of process 400. The computer can perform these steps automatically, or at least partially through interactions with a user.

In step 401 of process 400, a spanning tree can be selected for the quantum circuit. A spanning tree can be a subset of components within the quantum circuit. In some embodiments, the spanning tree can include all junctions, all voltage sources, and at least some inductors in the quantum circuit. The observables of these components can fully determine the state of the entire quantum circuit. It is appreciated that a quantum circuit may include multiple spanning trees, each associated with a different Hamiltonian. Use of different spanning trees can lead to different magnitudes of the coupling terms in the transformed Hamiltonian.

In some embodiments, a set of spanning trees can be determined for the quantum circuit. A previously unselected spanning tree can then be selected from this set. The set may include all potential spanning trees for the quantum circuit or a subset of the potential spanning trees for the quantum. In some embodiments, the selection can be performed automatically by a computing device. In various embodiments, the selection can be performed manually by a user (e.g., through interactions between the computing device and the user). The disclosed embodiments are not limited to any particular method of selecting the spanning tree. Process 400 can repeat until all spanning trees in the set have been selected.

In step 403 of process 400, an original Hamiltonian for the quantum circuit 403 can be determined, based on the selected spanning tree. The original Hamiltonian can be determined according to the method described above with regards to step 303 of process 300. The original Hamiltonian can include a charge coupling matrix and a flux coupling matrix.

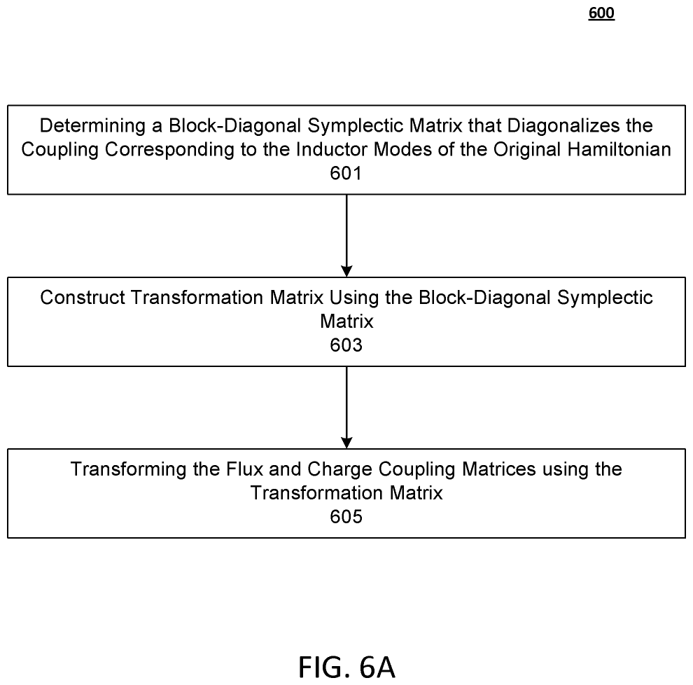

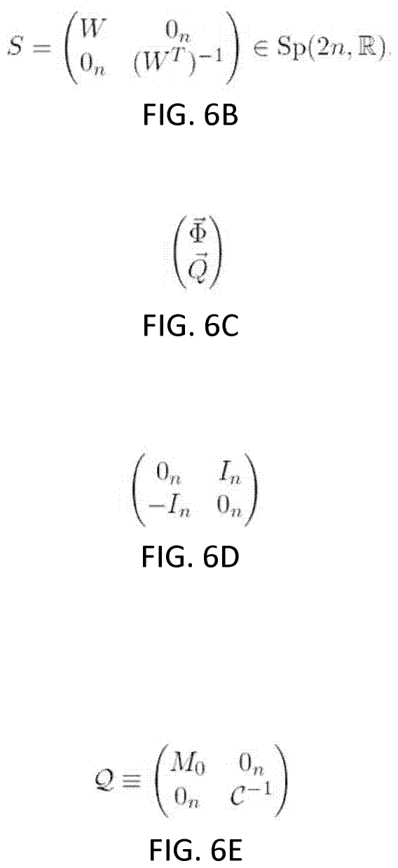

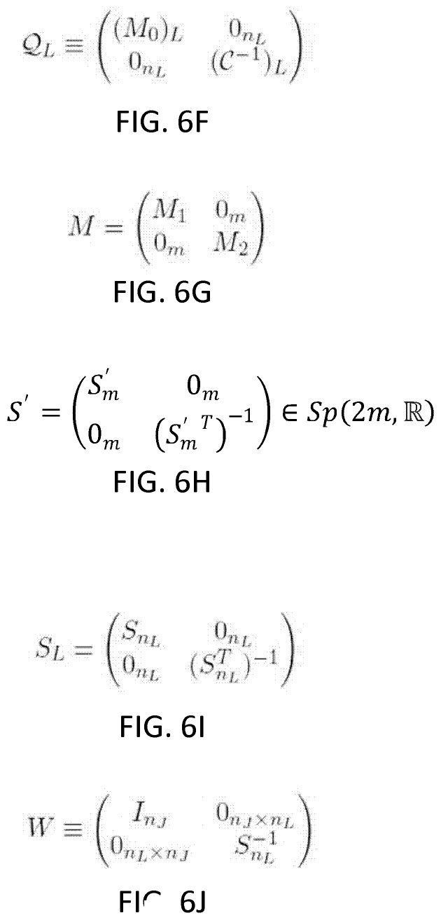

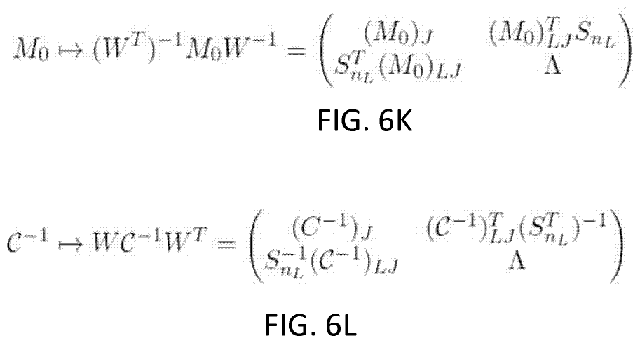

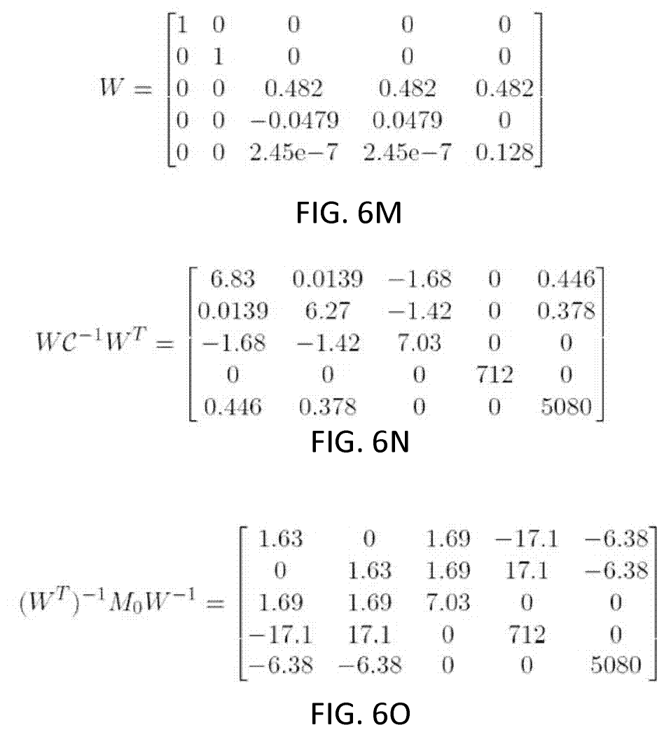

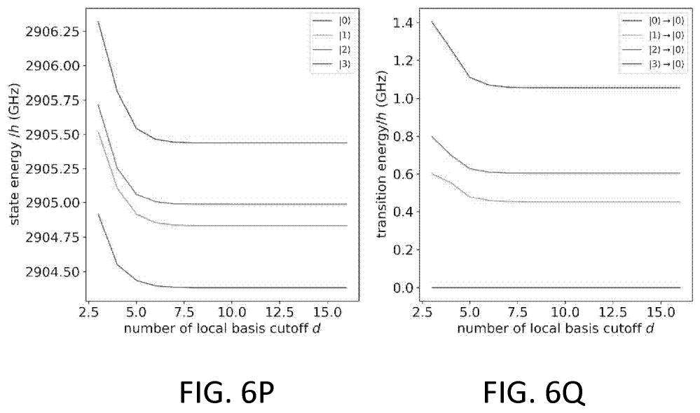

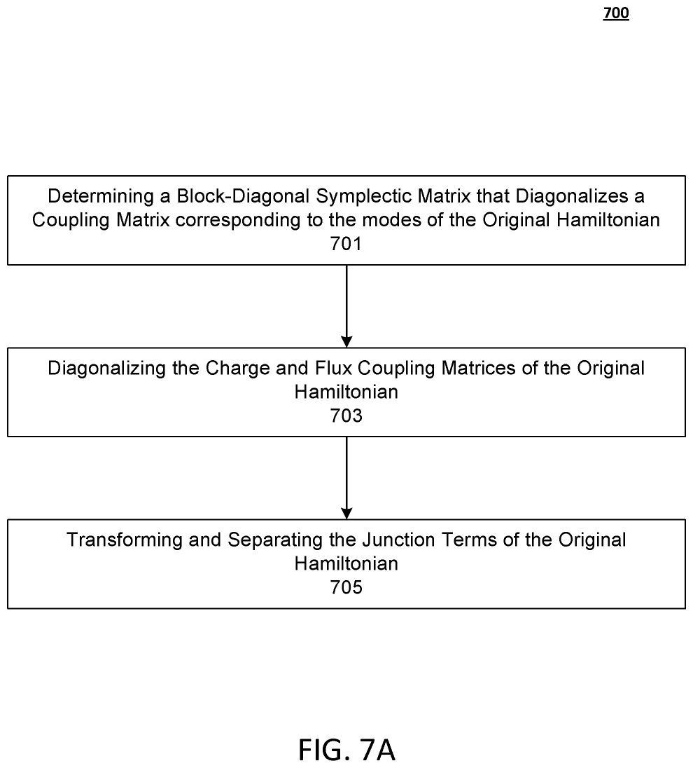

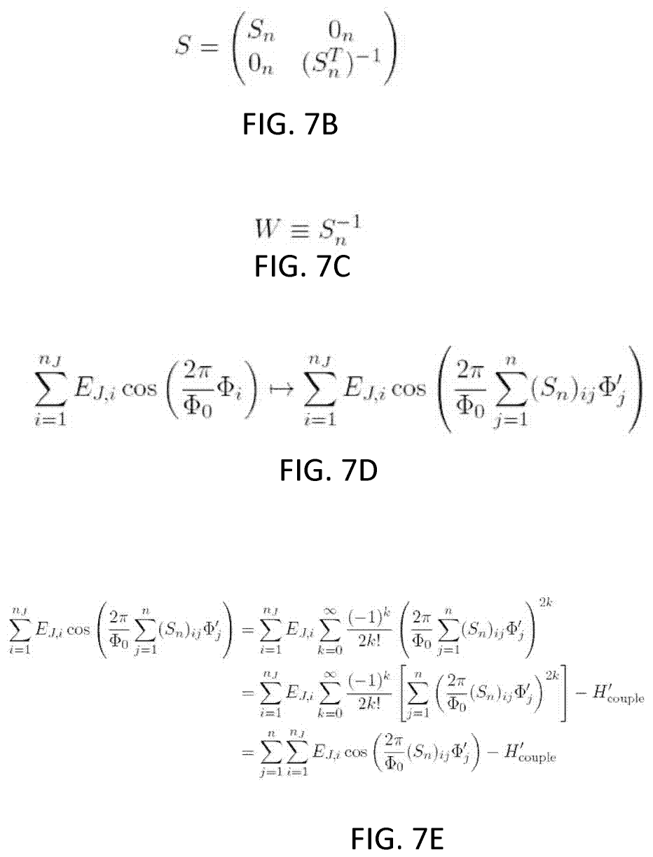

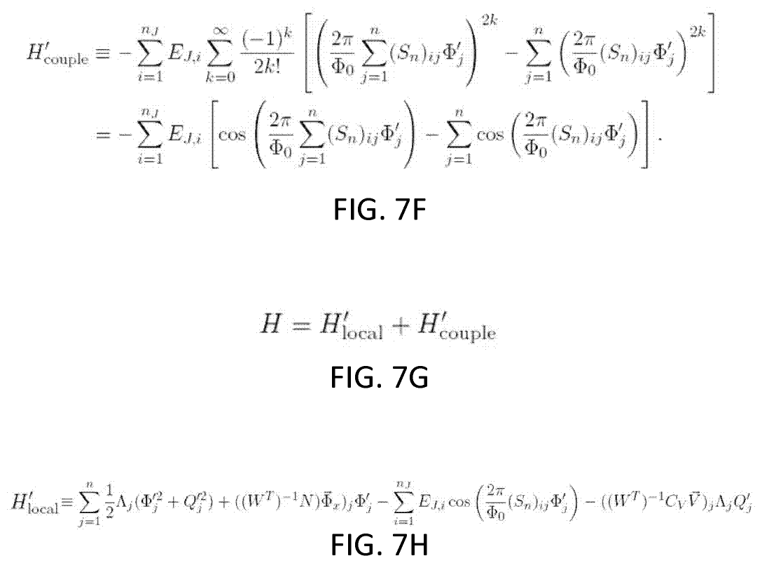

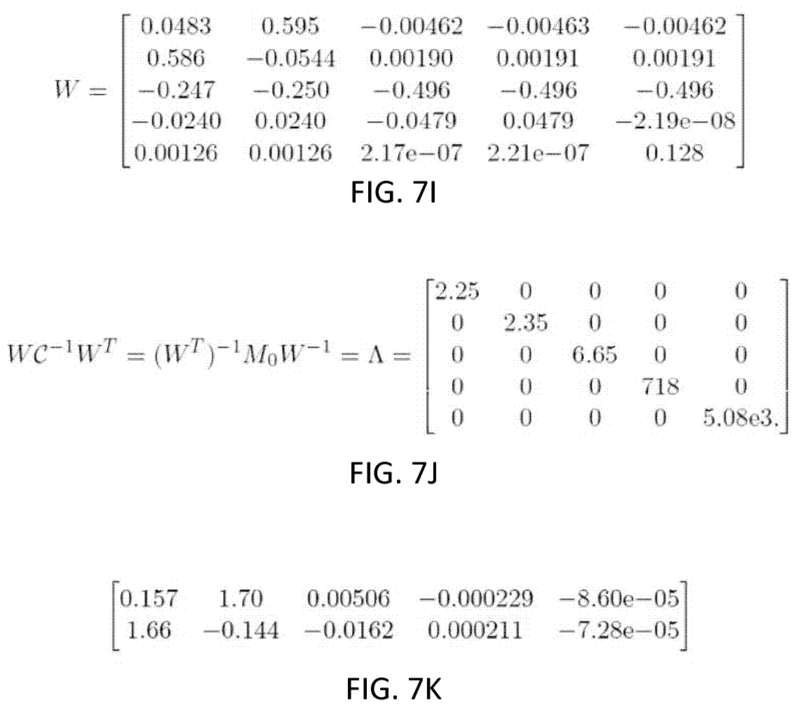

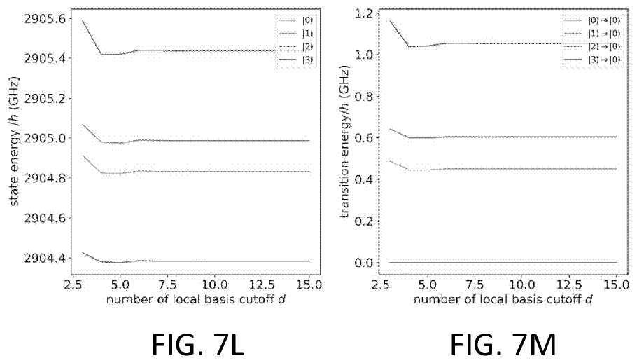

In step 405 of process 400, one or more linear transformations of the modes of the original Hamiltonian can be determined. Each of the one or more linear transformations can be one of the linear transformations described herein. In some instances, such a linear transformation can implement a simultaneous approximate diagonalization (as described with regards to FIG. 5A). In some embodiments, the linear transformation can depend on a block-diagonal symplectic matrix. The block-diagonal symplectic matrix can include a first submatrix and a second submatrix, the second submatrix being a function of the first submatrix. For example, in various instances, the linear transformation can implement an inductor-only symplectic diagonalization (e.g., as described with regards to FIG. 6A). In such instances, the block-diagonal symplectic matrix can be configured to diagonalize a submatrix of the flux coupling matrix, the submatrix corresponding to the inductor modes of the Hamiltonian. As an additional example, in some instances, the linear transformation can implement a full symplectic diagonalization (e.g., as described with regards to FIG. 7A). In such instances, the block-diagonal symplectic matrix can be configured to diagonalize the charge coupling matrix and the flux coupling matrix.

In step 407 of process 400, an at least partially decoupled Hamiltonian can be generated using the one or more linear transformations of the modes of the original Hamiltonian. In some embodiments, each potential linear transformation can be performed, and the resulting transformed Hamiltonians compared. In various embodiments, a subset of the potential linear transformation can be performed.

In step 409 of process 400, a coupling value can be determined for the at least partially decoupled Hamiltonian. The coupling value can indicate a degree of coupling between the modes of the at least partially decoupled Hamiltonian. When the linear transformation implements a simultaneous approximate diagonalization or an inductor-only symplectic diagonalization, the coupling value can be a function of off-diagonal elements of the transformed charge coupling matrix and transformed flux coupling matrix (e.g., a sum of squares of the off-diagonal elements of the transformed charge coupling matrix and transformed flux coupling matrix, or the like). When the linear transformation implements a full symplectic diagonalization, the coupling value can be a function of certain rows of the first submatrix of the block-diagonal symplectic matrix (e.g., those rows corresponding to junction modes of the original Hamiltonian). Such a function can include the sum of squares of the elements of these rows, or the like.

In step 411 of process 400, the at least partially decoupled Hamiltonian generated in step 407 can be selected as the transformed Hamiltonian for use in process 300. This selection can be based on the coupling value associated with the at least partially decoupled Hamiltonian. In some embodiments, one or more at least partially decoupled Hamiltonians can be generated for all spanning trees in the set, prior to selection of the transformed Hamiltonian. In such embodiments, the selection can depend on the coupling values associated with all of these at least partially decoupled Hamiltonians. For example, the at least partially decoupled Hamiltonian having the smallest magnitude coupling value can be selected as the transformed Hamiltonian.

In some embodiments, the at least partially decoupled Hamiltonian can be selected based on the coupling value associated with one at least partially decoupled Hamiltonian. For example, the selection criterion can concern a threshold coupling value (e.g., a predetermined value, or the like) or a threshold reduction in the coupling value (e.g., as compared to the same coupling value calculated for the original Hamiltonian). To continue this example, such a threshold reduction may be two or more orders of magnitude (e.g., a coupling value of the at least partially decoupled Hamiltonian is two or more orders of magnitude less than the coupling value of the original Hamiltonian). When an at least partially decoupled Hamiltonian satisfying the criterion (e.g., coupling value lower than the threshold value, coupling value reduction greater than the coupling value reduction threshold, etc.) is generated, process 400 may terminate and the at least partially decoupled Hamiltonian can be selected as the transformed Hamiltonian.

FIG. 5A depicts a flowchart of an exemplary simultaneous approximate diagonalization process 500 for generating a transformed Hamiltonian, in accordance with disclosed embodiments. Process 500 generates the transformed Hamiltonian using an orthogonal transformation. For such a transformation, the transformation matrix W=(W^{T})⁻¹. Transforming the original Hamiltonian using such an orthogonal transformation can be equivalent to simultaneously diagonalizing [symbol] ⁻¹ and M₀. However, in general, the two matrices do not commute, and so exact diagonalization may be impossible. Instead, an optimization task can be defined: finding an orthogonal matrix W such that the sum of the squares of the off-diagonal terms of the transformed matrices are minimized. However, the orthogonal transformation is restricted to the n_{L} tree inductor modes so that the cosine junction terms in the Hamiltonian does not have linear combinations of fluxes, which would make them into coupling terms. This technique will be referred to herein as the simultaneous approximate diagonalization. Process 500 can perform simultaneous approximate diagonalization based on an approach outlined in “Jacobi Angles for Simultaneous Diagonalization,” J. F. Cardoso and A. Souloumiac, SIAM Journal on Matrix Analysis and Applications, January 1996, which is hereby incorporated by reference herein in its entirety.

In step 501, process 500 can start. Process 500 can start as part of processes 400 or 300. For example, process 500 can be used to determine a transformation in step 405 of process 400. Process 400 can begin with a rotation matrix having the same dimensions as the flux coupling matrix and the charge coupling matrix of the original Hamiltonian. Process 400 can include successively updating this rotation matrix to generate the transformation matrix used to transform the original Hamiltonian. The rotation matrix can be updated by iteratively determining rotations around selected axes of the rotation matrix. In some embodiments, a computing device (e.g., as depicted in FIG. 8) can be configured to perform at least some of the steps of process 500. The computer can perform these steps automatically, or at least partially through interactions with a user.

In step 503 of process 500, an axis can be selected. The axis can be the next axis in a list or ordering of axis, or can be selected (e.g., randomly or deterministically) from a set of axes. The selected axis can correspond to an inductor mode in the original Hamiltonian.

In step 505 of process 500, a rotation value can be determined. The rotation value can be an angle of a rotation around the selected axis. The disclosed embodiments are not limited to any particular method of determining the rotation angle. In various embodiments, the rotation angle can be obtained using the close form equations disclosed in “Jacobi Angles for Simultaneous Diagonalization”, or another suitable method.

The rotation matrix can be updated to reflect a rotation of the rotation angle around the selected rotation axis. A transformed charge coupling matrix and a transformed flux coupling matrix can be determined using the updated rotation matrix. A termination value can be determined based on off-diagonal elements of the transformed charge coupling matrix and transformed flux coupling matrix. For example, the termination value can be a sum of the squares of the off-diagonal elements of these matrices. In some embodiments, while only the rotation axis corresponding to the inductor modes are iterated through, the termination values can be calculated over all modes, including junction modes.

In step 507 of process 500, a determination can be made regarding whether a stop condition is satisfied. In some embodiments, the stop condition can depend on the termination value associated with the rotation value (e.g., the termination value being less than an absolute or relative threshold) or a trend in the termination values associated with determined rotation values (e.g., a difference or derivative of the sequence of termination values satisfying a convergence criterion - such as being less than a convergence threshold value, or the like). In various embodiments, the stop condition can depend on an elapsed time, number of iterations, compute usage, or the like. If the stop condition is satisfied, then process 500 can proceed to step 509. If the stop condition is not satisfied, then process 500 can proceed to step 503 and another axis can be selected.

In step 509 of process 500, process 500 can stop. In some embodiments, a transformed Hamiltonian can be available (e.g., the transformed Hamiltonian may have been used to generate the last termination value). In such embodiments, process 500 can include both steps 405 and 407 of process 400. In some embodiments, the rotation matrix can be provided for use in generating the transformed Hamiltonian.

FIG. 5B depicts the orthogonal transformation matrix W, obtained by performing the simultaneous diagonalization technique described with regards to FIG. 5A to the quantum circuit of FIG. 1A. Note that the first two modes are junction modes and therefore do not transform. FIGS. 5C and 5D depict the transformed charge and flux coupling matrices generated (e.g., according to the mappings depicted in FIG. 31) using transformation matrix W and the original charge and flux coupling matrices depicted in FIG. 1D and 1E. With this transformation, the sum of the squares of the off-diagonal terms is reduced to 3.15e3, a reduction of seven orders of magnitude.

FIG. 5E depicts a plot of state energy for multiple energy levels as a function of local basis dimension. FIG. 5E depicts a plot of transition energy for different transitions as a function of local basis dimension. The state energies and plots are estimated using an at least partially decoupled Hamiltonian generated, as described herein, from the transformed Hamiltonian of FIGS. 5B to 5D. Comparing FIGS. 2A and 5E, the state energies converge more quickly than the case where no decoupling techniques are applied. Furthermore, the energies themselves are lower, which demonstrates the technological improvement provided by process 500.

FIG. 6A depicts a flowchart of an exemplary inductor-only symplectic diagonalization process 600 for generating a transformed Hamiltonian, in accordance with disclosed embodiments. Process 600 uses a more general linear transformation than process 500. In some embodiments, the linear transformation applied to the modes can be a symplectic transformation (e.g., given a matrix S as depicted in FIG. 6B, where 0ₙ is the n×n dimensional zero matrix, and a block matrix Ω as depicted in FIG. 6D, then S^{T}ΩS=Ω). The symplectic transformation can be on vector of the charges and fluxes of the Hamiltonian (e.g., FIG. 6C). In some embodiments, a computing device (e.g., as depicted in FIG. 8) can be configured to perform at least some of the steps of process 600. The computer can perform these steps automatically, or at least partially through interactions with a user.

In step 601 of process 600, a block-diagonal symplectic matrix can be determined. The block-diagonal symplectic matrix diagonalizes the coupling submatrix corresponding to the inductor modes of the original Hamiltonian of the quantum circuit. For example, in some embodiments, the flux coupling matrix M₀ can be positive definite. As a non-limiting example, when each Josephson junction in the quantum circuit is shunted by an inductor then flux coupling matrix M₀ is positive definite. Then the block matrix Q depicted in FIG. 6E (which encodes the quadratic part of the Hamiltonian) is positive definite. Since Q is positive definite, so is Q_{L}, the block matrix depicted in FIG. 6F that includes only the submatrices corresponding to L inductor modes in the Hamiltonian. Therefore, Williamson's theorem can be applied: given any positive definite matrix M∈ [symbol] ^{2m×2m}, there exists a symplectic matrix S∈Sp(2m, [symbol] ) such that S^{T}MS=diag(Λ, Λ), where Λ is a diagonal matrix with positive diagonal entries.

In a proof of Williamson's theorem, a normalized basis of eigenvectors B={v₁, . . . , vₙ, v₁*, . . . , vₙ*} can be constructed for the matrix iM^{-1/2}ΩM^{-1/2}, where

$$Ω = [ \begin{matrix}0 & I \\ - I & 0\end{matrix} ] ,$$

v₁ is an eignvector of iM^{-1/2}ΩM^{-1/2} having a corresponding eigenvalue λ, and v₁* is the elementwise complex conjugate of v₁ and an eignvector of iM^{-1/2}ΩM^{-1/2} having a corresponding eigenvalue −λ. An orthogonal matrix O=[x₁, . . . , xₙ, y₁, . . . , yₙ]∈ [symbol] ^{2n×2n} can be constructed using the eigenvectors of B, where xⱼ=vⱼ+vⱼ*/\sqrt{2} and yⱼ=i(vⱼ−vⱼ*/\sqrt{2}). Then S=M^{-1/2}O\tilde{D}^{-1/2}, where \tilde{D}=diag(D, D) and D=diag(λ₁, . . . , λₙ) is the diagonal of the positive eigenvalues of iM^{-1/2}ΩM^{-1/2} in the order corresponding to the order of the eigenvectors in B. Given this definition of S, it can be shown that S^{T}ΩS=Ω, and therefore S is symplectic.

Extending this proof, a stronger statement can be shown: given any block-diagonal positive definite matrix M as depicted in FIG. 6G, where M₁, M₂∈)^{m×m}, there exists a symplectic matrix S′ as depicted in FIG. 6H such that S′^{T}MS′=diag(Λ, Λ) where Λ is a diagonal matrix with positive diagonal entries. Through application of Williamson's theorem, the matrix Q_{L} can be diagonalized by a block diagonal symplectic matrix S_{L}, as depicted in FIG. 6I, such that S_{L}^{T}Q_{L}S_{L}=diag(Λ, Λ). The matrix S_{L} can be a block diagonal matrix including a first submatrix Sₙ_{_{L}} (an L×L matrix) and a second submatrix (Sₙ_{_{L}}^{T})⁻¹.

As a first step in determining the matrix S_{L}, given M, a basis B of eigenvectors can be constructed. A set of n eigenvectors {wᵢ, . . . , wₙ} of the real positive definite matrix M₂^{-1/2}M₁⁻¹M₂^{-1/2} having eigenvalues greater than zero can be determined. A corresponding set of n vectors {wᵢ′, . . . , wₙ′}, where

$${w}_{i}^{′} = \frac{i}{\sqrt{λ}} {M}_{1}^{- 1 / 2} {M}_{2}^{- 1 / 2} {w}_{i} .$$

It can be shown that the vector

$$[ \begin{matrix}{w}_{i}^{′} \\ {w}_{i}\end{matrix} ]$$

is an eigenvector of iM^{-1/2}ΩM^{-1/2}. Thus, as described above, the normalized basis of eigenvectors B={v₁, . . . , vₙ, v₁* , . . . , vₙ*} can be constructed for the matrix iM^{-1/2}ΩM^{-1/2}, where

$${v}_{j} = [ \begin{matrix}{w}_{j}^{′} \\ {w}_{j}\end{matrix} ] .$$

A matrix \tilde{D}=diag(D, D), can be constructed where D =diag(λ₁, . . . , λₙ) is the diagonal of the positive eigenvalues of iM^{-1/2}ΩM^{-1/2} in the order corresponding to the order of the eigenvectors in B. Then an orthogonal matrix O=[x₁, . . . , xₙ, y₁, . . . , yₙ]∈ [symbol] ^{2n×2n} can be constructed using the eigenvectors of B, where xⱼ=vⱼ+vⱼ*/\sqrt{2} and yⱼ=i(vⱼ−vⱼ*/\sqrt{2}). However, given the construction of the n vectors {wᵢ′, . . . , wₙ′},

$${x}_{j} = [ \begin{matrix}0 \\ {w}_{j}\end{matrix} ] and {y}_{j} = [ \begin{matrix}{iw}_{j}^{′} \\ 0\end{matrix} ] .$$

Therefore the matrix O is of the form

$$O = [ \begin{matrix}0 & {O}_{1} \\ {O}_{2} & 0\end{matrix} ] ,$$

and the matrix

$$S = {M}^{- 1 / 2} O {\tilde{D}}^{- 1 / 2} of the form S = [ \begin{matrix}0 & {M}_{1}^{- 1 / 2} {O}_{1} {D}^{- 1 / 2} \\ {M}_{2}^{- 1 / 2} {O}_{2} {D}^{- 1 / 2} & 0\end{matrix} ] .$$

Then matrix

$${S}_{L} = S Ω = [ \begin{matrix}- {M}_{1}^{- 1 / 2} {O}_{1} {D}^{- 1 / 2} & 0 \\ 0 & {M}_{2}^{- 1 / 2} {O}_{2} {D}^{- 1 / 2}\end{matrix} ]$$

$$where {S}_{{n}_{L}} = - {M}_{1}^{- 1 / 2} {O}_{1} {D}^{- 1 / 2} and {( {S}_{{n}_{L}}^{T} )}^{- 1} = {M}_{2}^{- 1 / 2} {O}_{2} {D}^{- 1 / 2} .$$

In step 603 of process 600, a transformation matrix can be generated using the block diagonal symplectic matrix S_{L}. In some embodiments, the linear transformation can be the matrix W depicted in FIG. 6J. As shown, this matrix is a block diagonal matrix including the first submatrix Sₙ_{_{L}}, the block identity matrix Iₙ_{_{J}} (a n_{J}×n_{J} matrix, where n_{J} is the number of junction modes), and zero matrices 0ₙ_{_{J}}_{×n}_{_{L}} and 0ₙ_{_{L}}_{×n}_{_{J}}.

In step 605 of process 600, the flux and charge coupling matrices of the original Hamiltonian can be transformed using the transformation matrix W. Applying this transformation can at least partially diagonalize the quadratic coupling matrices: flux coupling matrix M₀ can be transformed as depicted in FIG. 6K and the charge coupling matrix [symbol] ⁻¹ can be transformed as depicted in FIG. 6L. In these figures, the subscripts _{J} and _{JL} correspond to the submatrices for the junction modes and the coupling coefficients between junction and inductor modes, respectively. Recalling that Λ is an L×L diagonal matrix, this effectively fully decouples the inductor modes from each other. However, there might still be coupling between inductor modes and junction modes. The coupling between junction modes may be left intact.

As a non-limiting example, the inductor-only symplectic diagonalization decoupling technique of FIG. 6A can be applied to the original Hamiltonian of the quantum circuit of FIG. 1A. The matrix Q_{L} can include a submatrix M₀(3:5, 3:5) including the third through fifth rows and columns of M₀. The matrix Q_{L} can also include a submatrix [symbol] ⁻¹(3:5, 3:5) including the third through fifth rows and columns of [symbol] ⁻¹. A block-diagonal symplectic matrix S_{L} can be found that diagonalizes Q_{L}. A first submatrix Sₙ_{_{L}} of S_{L} can be used to generate matrix W depicted in FIG. 6M. As depicted in this figure, W is block diagonal, including the submatrix I₂ (e.g., the two-by-two identity matrix) in the rows and columns corresponding to the junction modes. As can be seen in FIGS. 6N and 6O, transforming M₀ and [symbol] ⁻¹ using W results in diagonalizing the modes corresponding to the induction terms of the original Hamiltonian.

In this non-limiting example, the sum of the squares of off-diagonal terms is 1.35e3. By way of comparison, the simultaneous approximate diagonalization method generated transformed M₀ and [symbol] ⁻¹ matrices having a sum of the squares of off-diagonal terms three times larger (1.35e3 versus 3.15e3) and a largest element among the off-diagonal terms that is more than twice as large (17.1 versus 39.30). This technique therefore provided an increased reduction in the magnitude of the off-diagonal terms. The decrease in the magnitude of the off-diagonal terms is matched by an improvement in the convergence of the low energy states, as depicted in FIG. 6P, and their differences, as depicted in FIG. 6Q. Both the state and transition energies converge more quickly than those of the simultaneous approximate diagonalization technique, depicted in FIG. 5E and 5F, and the no decoupling technique case, depicted in FIG. 2A and 2B.

FIG. 7A depicts a flowchart of an exemplary full symplectic diagonalization process 700 for generating a transformed Hamiltonian, in accordance with disclosed embodiments. Process 700 can be configured to fully diagonalize the quadratic part of the original Hamiltonian of the quantum circuit. As previously noted, when the flux coupling matrix M₀ is positive definite there exists, by Williamson's theorem for block diagonal matrices, a symplectic matrix as depicted in FIG. 7B, including a first diagonal submatrix (Sₙ) and a second diagonal submatrix ((Sₙ^{T})⁻¹), such that S^{T} [symbol] S=diag(Λ, Λ). In some embodiments, a computing device (e.g., as depicted in FIG. 8) can be configured to perform at least some of the steps of process 700. The computer can perform these steps automatically, or at least partially through interactions with a user.

In step 701 of process 700, a symplectic matrix as depicted in FIG. 7B can be determined, in accordance with the process described above with regards to step 601 of process 600. Unlike process 600, however, the matrix M in process 700 can include the entire flux coupling and charge coupling matrices. Accordingly, a linear transformation W of the modes of the original Hamiltonian can be defined as depicted in FIG. 7C.

In step 703 of process 700, the linear transformation W can be used to completely diagonalize the quadratic part of the Hamiltonian (e.g., according to the mappings depicted in FIGS. 3I and 3J), thereby removing all quadratic coupling terms. However, the transformed modes may still be coupled through a transformed junction term. As depicted in FIG. 7D, transforming the flux coupling matrix Φ→SₙΦ′ results in a dependence of the junction terms on the inductor modes. Furthermore, additional local terms may be present in the power series expansion of cosine.

In step 705 of process 700, these local terms can be separated from coupling terms as depicted in FIG. 7E and the transformed coupling Hamiltonian can be expressed as depicted in FIG. 7F. As described herein, the transformed Hamiltonian can be expressed in terms of a transformed local Hamiltonian and a transformed coupling Hamiltonian, as depicted in FIG. 7G, where the transformed local Hamiltonian includes junction terms, as depicted in FIG. 7H.

As a non-limiting example, the full symplectic diagonalization technique of FIG. 7A can be applied to the original Hamiltonian of the quantum circuit of FIG. 1A. First, a symplectic matrix as depicted in FIG. 7B, including a first diagonal submatrix (Sₙ), can be generated. The first submatrix can be used to generate a linear transformation W, as depicted in FIG. 7I. In contrast with the partial diagonalization approach of FIG. 6A, the junction modes are also transformed to fully diagonalize the coupling matrices. The linear transformation matrix can be used to diagonalize the charge and flux coupling matrices. In such embodiments, as depicted in FIG. 7J, the diagonalized charge and flux coupling matrices can be identical.

However, all the coupling terms may now be in the junction terms. The first n_{J}=2 rows of Sₙ=W⁻¹, depicted in FIG. 7K, can be used to determine these coupled junction terms, according to the equation depicted in FIG. 7F.

In this non-limiting example, as depicted in FIGS. 7L and 7M, the state and transition energies converge more quickly than those of the original Hamiltonian, as depicted in FIG. 2A and 2B, or the at least partially decoupled Hamiltonians generated by the methods depicted in FIGS. 5A and 6A. As depicted in these figures, the state and transition energies converge at between 5 and 7 local basis vectors.

For the full symplectic diagonalization technique, we could take one step further by first Taylor expanding the cosine junction term and adding the quadratic terms to M₀ That is, we map

$${M}_{0} ↦ {M}_{0} + {( \frac{2 π}{{Φ}_{0}} )}^{2} ( \begin{matrix}{M}_{{E}_{J}} & {0}_{{n}_{J} \times {n}_{L}} \\ {0}_{{n}_{L} \times {n}_{J}} & {0}_{{n}_{L}}\end{matrix} ) ,$$

where M_{E}_{_{J}} is the n_{J}×n_{J} diagonal matrix with the junction energies on the diagonal. If M₀ is positive definite, since E_{J,i}22 0 the mapping would preserve positive definiteness, and we can then apply full symplectic diagonalization with the new coupling matrices. This would in effect eliminate the quadratic coupling terms in FIG. 7F. However, the flux of the local systems might not be localized around zero, and so we may not be able to treat the low order terms in the cosine expansion perturbatively. Hence, eliminating the quadratic terms may not be what we want. This could be amended by expanding cosine around wherever the flux is localized for that local system.

FIG. 8 is a depiction of an example system 801 suitable for performing the disclosed methods, in accordance with disclosed embodiments. Although depicted as a server in FIG. 8, system 800 may comprise any computer, such as a desktop computer, a laptop computer, a tablet, or the like, configured to generate an at least partially decoupled Hamiltonian for a quantum circuit and simulate the quantum circuit using an at least partially decoupled Hamiltonian, using the methods described in FIGS. 5A, 6A, and 7A above. As depicted in FIG. 8, system 801 may have a processor 802. Processor 802 may comprise a single processor or a plurality of processors. For example, processor 802 may comprise a CPU, a GPU, a reconfigurable array (e.g., an FPGA or other ASIC), or the like. Processor 802 may be in communication with a memory 803, an input/output module 807, and a network interface controller (NIC) 809.

Memory 803 may comprise a single memory or a plurality of memories. In addition, memory 803 may comprise volatile memory, non-volatile memory, or a combination thereof. As depicted in FIG. 8, memory 803 may store one or more operating systems 804 and an optimizer 805. For example, optimizer 805 may include instructions to optimize a quantum circuit (e.g., as explained above). Therefore, optimizer 805 may simulate and optimize one or more quantum circuits according to any of the methods described above. Input/output module (I/O) 807 may store and retrieve data from one or more databases 808. For example, database(s) 808 may include data structures describing quantum circuits, for which decoupled Hamiltonians may be generated, consistent with disclosed embodiments. NIC 809 may connect system 801 to one or more computer networks. As illustrated by FIG. 8, NIC 809 may connects system 801 to a network 810. This network can be or include a wide area network (e.g., the internet), a local network, or the like. The network can be implemented using wired, wireless, cellular, or other communication technologies. The disclosed embodiments are not limited to any particular type of network or network implementation. System 801 may receive data and instructions over the network using MC 809 and may transmit data and instructions over the network using NIC 809.

The disclosed embodiments are not limited to implementation using a single computing device. For example, a system including multiple computing devices similar to system 801 (e.g., a cluster, or a cloud computing platform) can be configured to interoperated to perform the disclosed methods.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

The foregoing descriptions have been presented for purposes of illustration. They are not exhaustive and are not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

The embodiments may further be described using the following clauses:
1. A method for simulating a quantum circuit using a computer that processes bits, the method comprising: obtaining a representation of a quantum circuit; generating a transformed Hamiltonian corresponding to the quantum circuit, the transformed Hamiltonian comprising a transformed local Hamiltonian and a transformed coupling Hamiltonian; determining a limited eigenbasis including a number of eigenvectors of the transformed local Hamiltonian; projecting the transformed coupling Hamiltonian, the transformed coupling Hamiltonian expressed in terms of modes of the transformed local Hamiltonian, onto the limited eigenbasis; projecting the transformed local Hamiltonian onto the limited eigenbasis; generating an at least partially decoupled Hamiltonian by combining the projection of the transformed coupling Hamiltonian and the projection of the transformed local Hamiltonian; and simulating, by the computer, a behavior of the quantum circuit using the at least partially decoupled Hamiltonian.
2. The method of clause 1, wherein generating the transformed Hamiltonian comprises: repeatedly generating at least partially decoupled Hamiltonians and corresponding coupling values, a repeat comprising: selecting a spanning tree for the quantum circuit; determining an original Hamiltonian for the quantum circuit using the spanning tree, the original Hamiltonian including a charge coupling matrix and a flux coupling matrix; determining a linear transformation of the modes of the original Hamiltonian; generating an at least partially decoupled Hamiltonian using the linear transformation; and determining a corresponding coupling value for the at least partially decoupled Hamiltonian; and selecting as the transformed Hamiltonian the at least partially decoupled Hamiltonian based on the corresponding coupling value.
3. The method of clause 2, wherein: the linear transformation depends on a block-diagonal symplectic matrix, the block-diagonal symplectic matrix including a first submatrix and a second submatrix, the second submatrix being a function of the first submatrix.
4. The method of clause 3, wherein: generating the at least partially decoupled Hamiltonian using the linear transformation comprises diagonalizing the charge coupling matrix and the flux coupling matrix using the block-diagonal symplectic matrix; and the corresponding coupling value depends on rows of the first submatrix corresponding to junction modes of the original Hamiltonian.
5. The method of clause 3, wherein: generating an at least partially decoupled Hamiltonian using the linear transformation comprises: generating a first transformation matrix using the block-diagonal symplectic matrix; transforming the charge coupling matrix by diagonalizing a submatrix of the charge coupling matrix using the first transformation matrix, the submatrix of the charge coupling matrix corresponding to inductor modes of the original Hamiltonian; generating a second transformation matrix using the block-diagonal symplectic matrix; and transforming the flux coupling matrix by diagonalizing a submatrix of the flux coupling matrix, the submatrix of the flux coupling matrix corresponding to the inductor modes; and the corresponding coupling value depends on off-diagonal elements of the transformed charge coupling matrix and transformed flux coupling matrix.
6. The method of clause 2, wherein: determining the linear transformation comprises: generating a rotation matrix by iteratively determining rotations around axes of the rotation matrix, the axes corresponding to inductor modes in the original Hamiltonian.
7. The method of any one of clauses 3 to 5, wherein: the method further comprises generating the block-diagonal symplectic matrix, generation including: determining an initial block-diagonal matrix including the flux coupling matrix and the charge coupling matrix; determining a Hermitian matrix based on the initial block-diagonal matrix; determining an eigenbasis for the Hermitian matrix and a matrix of eigenvalues corresponding to the eigenbasis; and determining the block-diagonal symplectic matrix using the initial block-diagonal matrix, the eigenbasis for the Hermitian matrix, and the matrix of corresponding eigenvalues.
8. The method of clause 1, wherein generating the transformed Hamiltonian comprises at least partially decoupling an original Hamiltonian corresponding to the quantum circuit.
9. The method of clause 8, wherein at least partially decoupling the original Hamiltonian comprises diagonalizing at least one inductor mode of a quadratic portion of the original Hamiltonian.
10. A system for simulating a quantum circuit using a computer that processes bits, comprising: at least one processor; and at least one computer-readable medium containing instructions that, when executed by the at least one processor, cause the system to perform operations comprising: generating a transformed Hamiltonian corresponding to a quantum circuit, the transformed Hamiltonian including a transformed local Hamiltonian and a transformed coupling Hamiltonian, generation comprising: obtaining a charge coupling matrix and a flux coupling matrix of an original Hamiltonian corresponding to the quantum circuit; at least partially diagonalizing the charge coupling matrix and the flux coupling matrix; determining a limited eigenbasis including a number of eigenvectors of the transformed local Hamiltonian; projecting the transformed coupling Hamiltonian, expressed in terms of modes of the transformed local Hamiltonian, onto the limited eigenbasis; projecting the transformed local Hamiltonian onto the limited eigenbasis; generating an at least partially decoupled Hamiltonian by combining the projection of the transformed coupling Hamiltonian and the projection of the transformed local Hamiltonian; and simulating a behavior of the quantum circuit using the at least partially decoupled Hamiltonian.
11. The system of clause 10, wherein: the at least partially diagonalizing the charge coupling matrix and the flux coupling matrix comprises: generating a rotation matrix by iterating through axes of the rotation matrix, the axes corresponding to inductor modes of the original Hamiltonian, an iteration around one of the axes comprising: updating the rotation matrix to implement a rotation around the one of the axes.
12. The system of clause 11, wherein: the axes of the rotation matrix are iterated through until a value of a function of off-diagonal terms of the charge coupling matrix and the flux coupling matrix satisfies a termination condition.
13. The system of clause 10, wherein: the at least partially diagonalizing the charge coupling matrix and the flux coupling matrix comprises: generating a block-diagonal matrix using the charge coupling matrix and the flux coupling matrix; generating a block-diagonal symplectic matrix that diagonalizes the block-diagonal matrix; generating a transformation matrix using the block-diagonal symplectic matrix; and transforming the charge coupling matrix and the flux coupling matrix using the transformation matrix.
14. The system of clause 13, wherein: generating the block-diagonal symplectic matrix comprises: determining a Hermitian matrix based on the block-diagonal matrix; determining an eigenbasis for the Hermitian matrix and a matrix of eigenvalues corresponding to the eigenbasis; and determining the block-diagonal symplectic matrix using the block-diagonal matrix, the eigenbasis for the Hermitian matrix, and the matrix of corresponding eigenvalues.
15. The system of any one of clauses 10 to 13, wherein: each Josephson junction in the quantum circuit is shunted by an inductor.
16. The system of clause 13, wherein: the transformation matrix is generated in response to a determination that the flux coupling matrix is positive-definite.
17. The system of any one of clauses 13 or 16, wherein: the transformation matrix comprises a block-diagonal matrix including two submatrices: an identity submatrix; and an inverse of a submatrix of the block-diagonal symplectic matrix.
18. The system of any one of clauses 13 to 17, wherein: the block-diagonal matrix includes only submatrices of the charge coupling matrix and the flux coupling matrix corresponding to inductor modes of the original Hamiltonian.
19. The system of any one of clauses 13 to 16, wherein: the transformed local Hamiltonian includes transformed Josephson junction terms; or the flux coupling matrix and charge coupling matrix of the transformed Hamiltonian are identical.
20. A non-transitory computer-readable medium containing instructions that are executable by at least one processor of a system to cause the system to perform operations comprising: generating a transformed Hamiltonian corresponding to a quantum circuit, the transformed Hamiltonian including a transformed local Hamiltonian and a transformed coupling Hamiltonian, generation comprising: obtaining a charge coupling matrix and a flux coupling matrix of an original Hamiltonian corresponding to the quantum circuit; at least partially diagonalizing the charge coupling matrix and the flux coupling matrix; determining a limited eigenbasis including a number of eigenvectors of the transformed local Hamiltonian; projecting the transformed coupling Hamiltonian, expressed in terms of modes of the transformed local Hamiltonian, onto the limited eigenbasis; projecting the transformed local Hamiltonian onto the limited eigenbasis; generating an at least partially decoupled Hamiltonian by combining the projection of the transformed coupling Hamiltonian and the projection of the transformed local Hamiltonian; and simulating, by a computer that processes bits, a behavior of the quantum circuit using the at least partially decoupled Hamiltonian.

In the drawings and specification, there have been disclosed exemplary embodiments. However, many variations and modifications can be made to these embodiments. Accordingly, although specific terms are employed, they are used in a generic and descriptive sense only and not for purposes of limitation or restriction of the scope of the embodiments, the scope being defined by the following claims.

What is claimed is:

1. A method for simulating a quantum circuit using a computer that processes bits, the method comprising:
obtaining a representation of a quantum circuit;
generating a transformed Hamiltonian corresponding to the quantum circuit, the transformed Hamiltonian comprising a transformed local Hamiltonian and a transformed coupling Hamiltonian;
determining a limited eigenbasis including a number of eigenvectors of the transformed local Hamiltonian;
projecting the transformed coupling Hamiltonian, the transformed coupling Hamiltonian expressed in terms of modes of the transformed local Hamiltonian, onto the limited eigenbasis;
projecting the transformed local Hamiltonian onto the limited eigenbasis;
generating an at least partially decoupled Hamiltonian by combining the projection of the transformed coupling Hamiltonian and the projection of the transformed local Hamiltonian; and
simulating, by the computer, a behavior of the quantum circuit using the at least partially decoupled Hamiltonian.

2. The method of claim 1, wherein generating the transformed Hamiltonian comprises:
repeatedly generating at least partially decoupled Hamiltonians and corresponding coupling values, a repeat comprising:
selecting a spanning tree for the quantum circuit;
determining an original Hamiltonian for the quantum circuit using the spanning tree, the original Hamiltonian including a charge coupling matrix and a flux coupling matrix;
determining a linear transformation of the modes of the original Hamiltonian;
generating an at least partially decoupled Hamiltonian using the linear transformation; and
determining a corresponding coupling value for the at least partially decoupled Hamiltonian; and
selecting as the transformed Hamiltonian the at least partially decoupled Hamiltonian based on the corresponding coupling value.

3. The method of claim 2, wherein:
the linear transformation depends on a block-diagonal symplectic matrix, the block-diagonal symplectic matrix including a first submatrix and a second submatrix, the second submatrix being a function of the first submatrix.

4. The method of claim 3, wherein:
generating the at least partially decoupled Hamiltonian using the linear transformation comprises diagonalizing the charge coupling matrix and the flux coupling matrix using the block-diagonal symplectic matrix; and
the corresponding coupling value depends on rows of the first submatrix corresponding to junction modes of the original Hamiltonian.

5. The method of claim 3, wherein:
generating an at least partially decoupled Hamiltonian using the linear transformation comprises:
generating a first transformation matrix using the block-diagonal symplectic matrix;
transforming the charge coupling matrix by diagonalizing a submatrix of the charge coupling matrix using the first transformation matrix, the submatrix of the charge coupling matrix corresponding to inductor modes of the original Hamiltonian;
generating a second transformation matrix using the block-diagonal symplectic matrix; and
transforming the flux coupling matrix by diagonalizing a submatrix of the flux coupling matrix, the submatrix of the flux coupling matrix corresponding to the inductor modes; and
the corresponding coupling value depends on off-diagonal elements of the transformed charge coupling matrix and transformed flux coupling matrix.

6. The method of claim 2, wherein:
determining the linear transformation comprises:
generating a rotation matrix by iteratively determining rotations around axes of the rotation matrix, the axes corresponding to inductor modes in the original Hamiltonian.

7. The method of claim 3, wherein:
the method further comprises generating the block-diagonal symplectic matrix, generation including:
determining an initial block-diagonal matrix including the flux coupling matrix and the charge coupling matrix;
determining a Hermitian matrix based on the initial block-diagonal matrix;
determining an eigenbasis for the Hermitian matrix and a matrix of eigenvalues corresponding to the eigenbasis; and
determining the block-diagonal symplectic matrix using the initial block-diagonal matrix, the eigenbasis for the Hermitian matrix, and the matrix of corresponding eigenvalues.

8. The method of claim 1, wherein generating the transformed Hamiltonian comprises at least partially decoupling an original Hamiltonian corresponding to the quantum circuit.

9. The method of claim 8, wherein at least partially decoupling the original Hamiltonian comprises diagonalizing at least one inductor mode of a quadratic portion of the original Hamiltonian.

10. A system for simulating a quantum circuit using a computer that processes bits, comprising:
at least one processor; and
at least one computer-readable medium containing instructions that, when executed by the at least one processor, cause the system to perform operations comprising:
generating a transformed Hamiltonian corresponding to a quantum circuit, the transformed Hamiltonian including a transformed local Hamiltonian and a transformed coupling Hamiltonian, generation comprising:
obtaining a charge coupling matrix and a flux coupling matrix of an original Hamiltonian corresponding to the quantum circuit;
at least partially diagonalizing the charge coupling matrix and the flux coupling matrix;
determining a limited eigenbasis including a number of eigenvectors of the transformed local Hamiltonian;
projecting the transformed coupling Hamiltonian, expressed in terms of modes of the transformed local Hamiltonian, onto the limited eigenbasis;
projecting the transformed local Hamiltonian onto the limited eigenbasis;
generating an at least partially decoupled Hamiltonian by combining the projection of the transformed coupling Hamiltonian and the projection of the transformed local Hamiltonian; and
simulating a behavior of the quantum circuit using the at least partially decoupled Hamiltonian.

11. The system of claim 10, wherein:
the at least partially diagonalizing the charge coupling matrix and the flux coupling matrix comprises:
generating a rotation matrix by iterating through axes of the rotation matrix, the axes corresponding to inductor modes of the original Hamiltonian, an iteration around one of the axes comprising:
updating the rotation matrix to implement a rotation around the one of the axes.

12. The system of claim 11, wherein:
the axes of the rotation matrix are iterated through until a value of a function of off-diagonal terms of the charge coupling matrix and the flux coupling matrix satisfies a termination condition.

13. The system of claim 10, wherein:
the at least partially diagonalizing the charge coupling matrix and the flux coupling matrix comprises:
generating a block-diagonal matrix using the charge coupling matrix and the flux coupling matrix;
generating a block-diagonal symplectic matrix that diagonalizes the block-diagonal matrix;
generating a transformation matrix using the block-diagonal symplectic matrix; and
transforming the charge coupling matrix and the flux coupling matrix using the transformation matrix.

14. The system of claim 13, wherein:
generating the block-diagonal symplectic matrix comprises:
determining a Hermitian matrix based on the block-diagonal matrix;
determining an eigenbasis for the Hermitian matrix and a matrix of eigenvalues corresponding to the eigenbasis; and
determining the block-diagonal symplectic matrix using the block-diagonal matrix, the eigenbasis for the Hermitian matrix, and the matrix of corresponding eigenvalues.

15. The system of claim 13, wherein:
each Josephson junction in the quantum circuit is shunted by an inductor.

16. The system of claim 13, wherein:
the transformation matrix is generated in response to a determination that the flux coupling matrix is positive-definite.

17. The system of claim 13, wherein:
the transformation matrix comprises a block-diagonal matrix including two submatrices:
an identity submatrix; and
an inverse of a submatrix of the block-diagonal symplectic matrix.

18. The system of claim 13, wherein:
the block-diagonal matrix includes only submatrices of the charge coupling matrix and the flux coupling matrix corresponding to inductor modes of the original Hamiltonian.

19. The system of claim 13, wherein:
the transformed local Hamiltonian includes transformed Josephson junction terms; or
the flux coupling matrix and charge coupling matrix of the transformed Hamiltonian are identical.

20. A non-transitory computer-readable medium containing instructions that are executable by at least one processor of a system to cause the system to perform operations comprising:
generating a transformed Hamiltonian corresponding to a quantum circuit, the transformed Hamiltonian including a transformed local Hamiltonian and a transformed coupling Hamiltonian, generation comprising:
obtaining a charge coupling matrix and a flux coupling matrix of an original Hamiltonian corresponding to the quantum circuit;
at least partially diagonalizing the charge coupling matrix and the flux coupling matrix;
determining a limited eigenbasis including a number of eigenvectors of the transformed local Hamiltonian;
projecting the transformed coupling Hamiltonian, expressed in terms of modes of the transformed local Hamiltonian, onto the limited eigenbasis;
projecting the transformed local Hamiltonian onto the limited eigenbasis;
generating an at least partially decoupled Hamiltonian by combining the projection of the transformed coupling Hamiltonian and the projection of the transformed local Hamiltonian; and
simulating, by a computer that processes bits, a behavior of the quantum circuit using the at least partially decoupled Hamiltonian.
